(19) United States
(12) Patent Application Publication
(10) Pub. No.: US 2009/0257539 A1
(43) Pub. Date: Oct. 15, 2009

(54) TRANSMISSION APPARATUS AND METHOD, RECEPTION APPARATUS AND METHOD, PROGRAM, AND TRANSMISSION AND RECEPTION SYSTEM AND METHOD

(75) Inventors: Naoki INOMATA, Kanagawa (JP); Koji Fujimiya, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/400,464

(22) Filed: Mar. 9, 2009

(30) Foreign Application Priority Data
Apr. 15, 2008 (JP) 2008-105745

(51) Int. Cl. H04L 7/02

(52) U.S. Cl. 375/359

(57) ABSTRACT

Disclosed herein is a transmission apparatus, including: a control section configured to control the timing at which actual data from a data source is to be transmitted to a reception apparatus; and a transmission section configured to produce a control signal representative of the contents of the control of the control section, transmit the control signal to the reception apparatus through a first signal line, receive the actual data from the data source under the control of the control section and transmit the received actual data to the reception apparatus through a second signal line.

### BACKGROUND OF THE INVENTION

1. Field of the Invention

This invention relates to a transmission apparatus and method, a reception apparatus and method, a program, and a transmission and reception system and method.

2. Description of the Related Art

When actual data is to be transmitted from a data transmission apparatus to a data reception apparatus, a header is transmitted immediately prior to transmission of the actual data to notify the data reception apparatus of a start of data transmission. Further, if the data length of the actual data is known, then the data reception apparatus can know an end of the actual data if the data length of the actual data is indicated in the header. The method just described is disclosed, for example, in Japanese Patent Laid-Open No. 2002-222193 (hereinafter referred to as Patent Document 1).

### SUMMARY OF THE INVENTION

However, according to existing methods including the method of Patent Document 1, where the data length of actual data is indefinite as in the case of continuous moving picture data, the data transmission apparatus side buffers actual data inputted from a data source to settle the data length and then produces a header including information of the data length. In other words, the existing methods have a problem that a buffer is required.

Therefore, it is desirable to provide a transmission apparatus and method, a reception apparatus and method, a program, and a transmission and reception system and method by which the necessity for a required buffer as a component of the data transmission apparatus side in the past can be eliminated.

According to an embodiment of the present invention, there is provided a transmission apparatus including control means for controlling the timing at which actual data from a data source is to be transmitted to a reception apparatus, and transmission means for producing a control signal representative of the contents of the control of the control means, transmitting the control signal to the reception apparatus through a first signal line, receiving the actual data from the data source under the control of the control means and transmitting the received actual data to the reception apparatus through a second signal line.

Preferably, the transmission apparatus further includes metadata production means for producing metadata regarding the actual data, the control means further controlling the timing at which the metadata produced by the metadata production means is to be transmitted, the transmission means being further operable to produce the control signal so as to further include the contents of the control of the transmission timing of the metadata, transmit the control signal through the first signal line and further transmit the metadata to the reception apparatus through the second transmission line.

In this instance, the metadata production means may produce, as the metadata, start metadata indicative of a start of transmission of the actual data and end metadata indicative of an end of the transmission of the actual data.

Or, the transmission apparatus may be configured such that the control means is associated with a plurality of data sources, and the metadata production means produces the metadata so as to include data source information for specifying one of the data sources from which the actual data is outputted. In this instance, preferably the control means further carries out control of changing over the operative data source from which actual data of an object of transmission is to be outputted, and the metadata production means further produces, when the operative data source is changed over from a first one of the data sources to a second one of the data sources under the control of the control means, intermediate metadata indicative of an interruption of transmission of actual data of the first data source, and thereafter produces, when the operative data source is changed over from the second data source to the first data source under the control of the control means, re-start metadata indicative of a re-start of the transmission of the actual data of the first data source.

Preferably, the metadata production means further produces data length metadata indicative of the data length of the actual data.

According to an embodiment of the present invention, also a method and a program corresponding to the transmission apparatus are provided.

In the transmission apparatus and method and the program, transmission timing control of actual data from the data source to the reception apparatus is carried out by the transmission apparatus, and a control signal representative of the contents of the transmission timing control is produced. Then, the control signal is transmitted to the reception apparatus through the first signal line. Then, the actual data from the data source is inputted to the transmission apparatus under the transmission timing control for the actual data, and the received actual data is transmitted to the reception apparatus through the second signal line.

According to another embodiment of the present invention, there is provided a reception apparatus including reception control means for receiving, when a control signal representative of contents of control regarding transmission timing of actual data is transmitted from a transmission apparatus, which transmits the actual data from a data source, through a first signal line and the actual data is transmitted from the transmission apparatus through a second signal line, the control signal and carrying out control of receiving the actual data based on the control signal.

Preferably, the reception apparatus is configured such that, when metadata regarding the actual data is transmitted further from the transmission apparatus through the second signal line and the control signal which further includes contents of control of transmission timing of the metadata is transmitted from the transmission apparatus through the first signal line, the reception control means further carries out control of receiving the metadata based on the control signal.

In this instance, preferably the reception apparatus further includes metadata interpretation means for interpreting the metadata received by the control of the reception control means to specify the type of the metadata.

The metadata specified by the metadata interpretation means may be one of start metadata indicative of a start of transmission of the actual data and end metadata indicative of an end of the transmission of the actual data.

Preferably, the metadata includes data source information for specifying one of a plurality of data sources associated with the transmission apparatus from which the actual data is outputted, and the metadata interpretation means further interprets the data source information to specify the data source.

The reception apparatus may be configured such that the actual data outputted from the data sources are outputted from the reception apparatus to respective outputting destinations determined in advance, and the reception apparatus further includes distribution means for distributing the actual data received by the reception control means to that one of the outputting destinations which corresponds to the data source specified by the metadata interpretation means.

The reception apparatus may be configured further such the metadata interpretation means specifies the metadata between interruption metadata produced by the transmission apparatus when the operative data source which is to output actual data of a transmission object is changed over from a first one of the data sources to a second one of the data sources and indicative of an interruption of transmission of actual data of the first data source and re-start metadata produced by the transmission apparatus when the data source is changed over from the second data source to the first data source and indicative of a re-start of the transmission of the actual data of the first data source, and the distribution means changes over, when the interruption metadata regarding the first data source is specified by the metadata interpretation means, the outputting destination of the actual data to any other than the outputting destination corresponding to the first data source, and then changes over, when the re-start metadata regarding the first data source is specified by the metadata interpretation means, the outputting destination of the actual data back to the outputting destination which corresponds to the first data source.

The metadata interpretation means may specify, as the metadata to be specified thereby, data length metadata representative of the data length of the actual data.

According to an embodiment of the present invention, also a method and a program corresponding to the reception apparatus are provided.

In the reception apparatus and method and the program, when a control signal representative of contents of control regarding transmission timing of actual data is transmitted from the transmission apparatus, which transmits the actual data from the data source, through the first signal line and the actual data is transmitted from the transmission apparatus through the second signal line, the control signal is received, and control of receiving the actual data based on the control signal is carried out.

According to a further embodiment of the present invention, there is provided a transmission and reception system including a transmission apparatus including control means for controlling the timing at which actual data from a data source is to be transmitted to a reception apparatus, and transmission means for producing a control signal representative of the contents of the control of the control means, transmitting the control signal to the reception apparatus through a first signal line, receiving the actual data from the data source under the control of the control means and transmitting the received actual data to the reception apparatus through a second signal line, and a reception apparatus including reception control means for receiving the control signal and carrying out control of receiving the actual data based on the control signal.

According to a still further embodiment of the present invention, there is provided a transmission and reception method including a step, carried out by a transmission apparatus, of carrying out control of the timing at which actual data from a data source is to be transmitted to a reception apparatus, a step, carried out by the transmission apparatus, of producing a control signal representative of the contents of the control and transmitting the control signal to the reception apparatus through a first signal line, a step, carried out by the transmission apparatus, of receiving the actual data from the data source under the control and transmitting the received actual data to the reception apparatus through a second signal line, and a step, carried out by the reception apparatus, of receiving the control signal and carrying out control of receiving the actual data based on the control signal.

With the transmission apparatus and method, reception apparatus and method, program, and transmission and reception system and method, actual data from the data source can be transmitted from the data transmission apparatus to the data reception apparatus. Particularly, the necessity for a buffer which is required by the existing methods described above can be eliminated particularly as a component of the data transmission apparatus side.

The above and other features and advantages of the embodiments of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing an example of a configuration of an information processing apparatus to which an embodiment of the present invention is applied;

FIG. 2 is a diagrammatic view illustrating an example of a configuration of metadata produced by a data transmission apparatus shown in FIG. 1;

FIG. 3 is a flow chart illustrating an example of a data transmission process carried out by the data transmission apparatus;

FIG. 4 is a diagrammatic view illustrating another example of a configuration of the metadata produced by the data transmission apparatus;

FIGS. 5A and 5B are a waveform diagram illustrating an example of a waveform of a metadata flag and a diagrammatic view illustrating an example of an arrangement configuration of metadata-superposed actual data, respectively, transmitted from the data transmission apparatus in the data transmission process of FIG. 3;

FIG. 6 is a flow chart illustrating an example of a data reception process carried out by a data reception apparatus shown in FIG. 1 and corresponding to the data transmission process of FIG. 3 carried out by the data transmission apparatus;

FIG. 7 is a flow chart illustrating another example of the data transmission process carried out by the data transmission apparatus;

FIG. 8 is a diagrammatic view illustrating an example of a configuration of data length metadata produced by the data transmission apparatus;

FIGS. 9A and 9B are a waveform diagram illustrating an example of a waveform of the metadata flag and a diagrammatic view illustrating an example of an arrangement configuration of the metadata-superposed actual data, respectively, transmitted from the data transmission apparatus in the data transmission process of FIG. 7;

FIG. 10 is a flow chart illustrating another example of the data reception process carried out by the data reception apparatus and corresponding to the data transmission process of FIG. 7 carried out by the data transmission apparatus;

FIGS. 11 and 12 are flow charts illustrating a further example of the data transmission process carried out by the data transmission apparatus;

FIGS. 13A, 13B and 13C are diagrammatic views illustrating an example of timing for data production from a data source shown in FIG. 1 in the data transmission process of FIGS. 11 and 12;

FIGS. 14A and 14B are a waveform diagram illustrating an example of a waveform of the metadata flag and a diagrammatic view illustrating an example of an arrangement configuration of the metadata-superposed actual data, respectively, transmitted from the data transmission apparatus in the data transmission process of FIGS. 11 and 12;

FIGS. 15 and 16 are flow charts illustrating a further example of the data reception process carried out by the data reception apparatus and corresponding to the data transmission process of FIGS. 11 and 12 carried out by the data transmission apparatus;

FIG. 17 is a flow chart illustrating a still further example of the data transmission process carried out by the data transmission apparatus;

FIGS. 18A, 18B, 18C and 18D are diagrammatic views illustrating an example of timing of data production from data sources shown in FIG. 1 in the data transmission process of FIG. 17;

FIGS. 19A and 19B are a waveform diagram illustrating an example of a waveform of the metadata flag and a diagrammatic view illustrating an example of an arrangement configuration of the metadata-superposed actual data, respectively, transmitted from the data transmission apparatus in the data transmission process of FIG. 17;

FIG. 20 is a flow chart illustrating a still further example of the data reception process carried out by the data reception apparatus and corresponding to the data transmission process of FIGS. 11 and 12 carried out by the data transmission apparatus; and

FIG. 21 is a block diagram showing an example of a hardware configuration of the information processing apparatus to which an embodiment of the present invention is applied.

### DETAILED DESCRIPTION OF THE PREFERRED EMBODIMENT

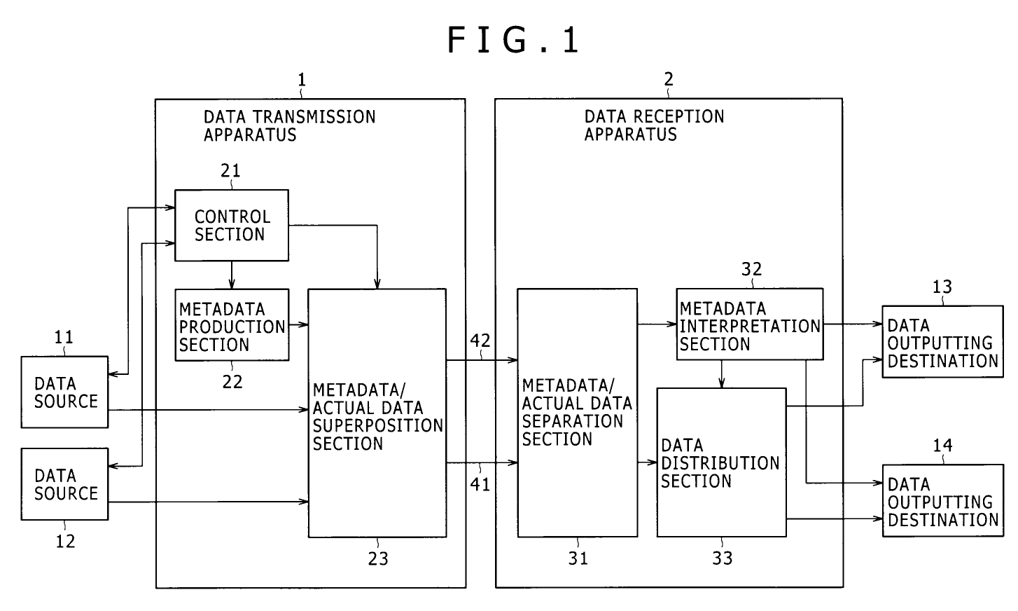

FIG. 1 shows an example of a configuration of an information processing system to which an embodiment of the present invention is applied.

Referring to FIG. 1, the information processing system shown includes a data transmission apparatus 1 and a data reception apparatus 2. The data transmission apparatus 1 and the data reception apparatus 2 are connected to each other by a data bus 41 and a control signal line 42.

The data transmission apparatus 1 receives data outputted from data sources 11 and 12, carries out suitably processing for the inputted data and outputs resulting data to the data reception apparatus 2.

The data reception apparatus 2 receives the data transmitted from the data transmission apparatus 1. The data reception apparatus 2 carries out suitable processing for the received data and outputs resulting data to a data outputting destination 13 or another data outputting destination 14.

It is to be noted here that, for simplified description, it is assumed that data outputted from the data source 11 is transmitted between the data transmission apparatus 1 and the data reception apparatus 2 and outputted to the data outputting destination 13. Further, it is assumed that data outputted from the data source 12 is transmitted between the data transmission apparatus 1 and the data reception apparatus 2 and outputted to the data outputting destination 14. Naturally, the inputting and outputting relationship of data may be reversed.

Here, the data outputted from the data source 11 or the data source 12 is target data of an object of transmission from the data transmission apparatus 1 to the data reception apparatus 2 and is, in the present embodiment, data of an image, sound and so forth. Therefore, in order to distinguish the data described from other data, the data is hereinafter referred to as actual data.

Meanwhile, data relating to actual data is hereinafter referred to generically as metadata. In the present embodiment, metadata is produced by the data transmission apparatus 1. The metadata is superposed on and transmitted together with the actual data to the data reception apparatus 2 by the data transmission apparatus 1. It is to be noted that actual data on which metadata is superposed in this manner is hereinafter referred to as metadata-superposed actual data.

The data transmission apparatus 1 includes a control section 21, a metadata production section 22 and a metadata/actual data superposition section 23.

The control section 21 controls operation of the entire data transmission apparatus 1. For example, the control section 21 controls the timing at which actual data from the data source 11 or the data source 12 is to be transmitted to the data reception apparatus 2. Further, the control section 21 controls transmission of various metadata to the data reception apparatus 2 at timing at which transmission of actual data stops.

The metadata production section 22 produces and outputs various metadata to the metadata/actual data superposition section 23 under the control of the control section 21.

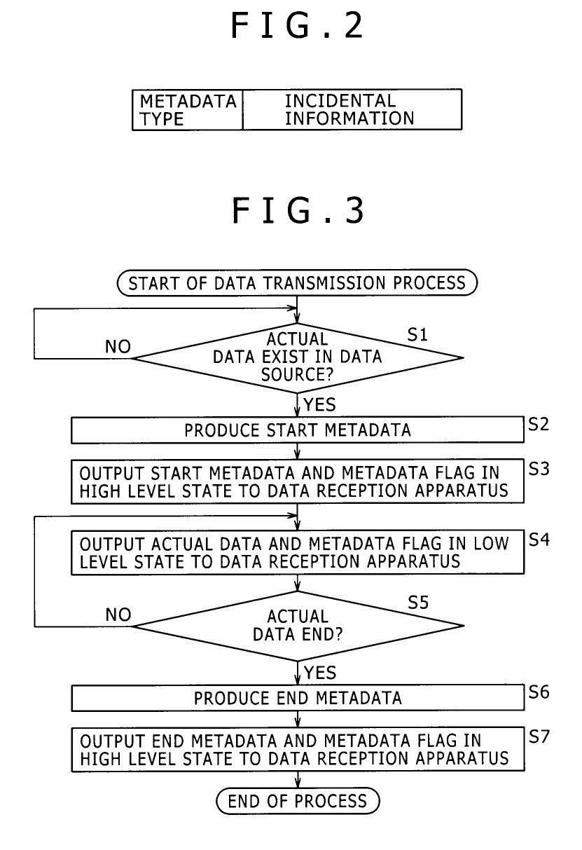

The metadata in the present embodiment has such a structure as illustrated in FIG. 2. Referring to FIG. 2, the metadata in the present embodiment includes a metadata type part and an incidental information part disposed in this order. In the metadata type part, information which specifies a type of the metadata is accommodated. In the incidental information part, various kinds of information according to the type of the metadata are accommodated. It is to be noted that various particular examples of metadata are hereinafter described.

The metadata/actual data superposition section 23 receives actual data from the data source 11 or the data source 12 and outputs the actual data to the data reception apparatus 2 through the data bus 41 under the control of the control section 21. Further, the metadata/actual data superposition section 23 receives metadata from the metadata production section 22 at a point of time while transmission of actual data stops and transmits the received metadata to the data reception apparatus 2 through the data bus 41. In other words, the metadata/actual data superposition section 23 produces metadata-superposed actual data and transmits the produced metadata-superposed actual data to the data reception apparatus 2 through the data bus 41.

Further, the metadata/actual data superposition section 23 produces a control signal indicative of transmission timing of actual data or metadata and transmits the control signal to the data reception apparatus 2 through the control signal line 42. The form of the control signal is not limited particularly. For example, in the present embodiment, the control signal is formed as a metadata flag. The metadata flag is a signal which exhibits the high level within a period within which metadata is transmitted from within a transmission period of metadata-superposed actual data buts exhibits the low level within another period within which the metadata is not transmitted. In other words, when the metadata is being transmitted, the metadata flag is in a set state. In contrast, when metadata is not transmitted, the metadata flag is in a reset state.

While the data transmission apparatus 1 has such a configuration as described above, the data reception apparatus 2 includes a metadata/actual data separation section 31, a metadata interpretation section 32 and a data distribution section 33.

The metadata/actual data separation section 31 receives metadata-superposed actual data inputted from the data transmission apparatus 1 through the data bus 41. Further, the metadata/actual data separation section 31 receives a control signal, that is, the metadata flag, inputted from the data transmission apparatus 1 through the control signal line 42.

The metadata/actual data separation section 31 separates the metadata-superposed actual data into metadata and actual data based on the metadata flag. The metadata after the separation is outputted from the metadata/actual data separation section 31 to the metadata interpretation section 32. Meanwhile, the actual data after the separation is outputted from the metadata/actual data separation section 31 to the data distribution section 33.

In particular, for example, the metadata/actual data separation section 31 recognizes a portion of the metadata-superposed actual data which is inputted at timing at which the metadata flag has the high level as metadata. Thus, the metadata/actual data separation section 31 separates and outputs the portion as metadata to the data distribution section 33.

Meanwhile, the metadata/actual data separation section 31 recognizes a portion of the metadata-superposed actual data which is inputted at timing at which the metadata flag has the low level as actual data. Thus, the metadata/actual data separation section 31 separates and outputs the portion as actual data to the data distribution section 33.

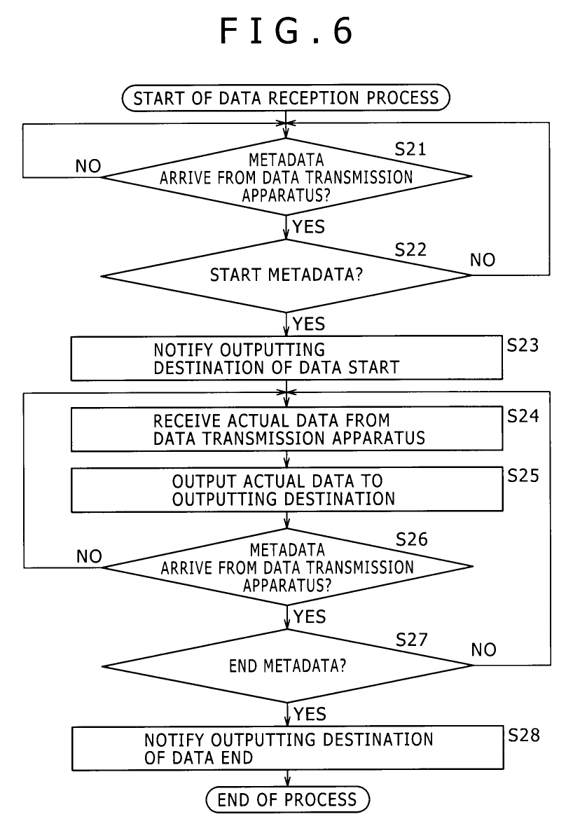

When the metadata interpretation section 32 receives metadata, it interprets the contents of the “metadata type part (refer to FIG. 2)” and sets the type of the metadata. Further, the metadata interpretation section 32 interprets the contents of the “incidental information part.” Then, the metadata interpretation section 32 notifies the data distribution section 33 of a result of the interpretation. The result of the interpretation of the metadata interpretation section 32 and information based on the interpretation result are suitably conveyed also to the data outputting destination 13 or the data outputting destination 14. Here, the information based on the interpretation result may be a data start (refer to step S23 of FIG. 6 hereinafter described) or a data end (refer to step S28 of FIG. 6 hereinafter described).

The data distribution section 33 selectively outputs the actual data to the data outputting destination 13 or the data outputting destination 14. The selection of the outputting destination of actual data in this instance is carried out based on a result of the interpretation of the metadata interpretation section 32. However, a particular selection method is hereinafter described with reference to FIG. 6.

In the following, various particular examples of processing executed by the information processing system of FIG. 1 are described with reference to FIG. 3 and so forth.

It is to be noted that the processing executed by the data transmission apparatus 1 is hereinafter referred to as data transmission process. Meanwhile, the processing executed by the data reception apparatus 2 is hereinafter referred to as data reception process.

FIG. 3 illustrates an example of the data transmission process. The example of FIG. 3 is an example of the data transmission process where the data source 11 is valid while the data source 12 is invalid and variable length data whose data length is not known is transmitted from the data transmission apparatus 1 to the data reception apparatus 2.

Referring to FIG. 3, first at step S1, the control section 21 of the data transmission apparatus 1 decides whether or not actual data exists in the data source 11.

If no actual data exists in the data source 11, then a decision of NO is made at step S1, and the processing returns to step S1 to repeat the process at step S1. In other words, the decision process at step S1 is repeated until after a state wherein actual data exists in the data source 11 is established, and a data transmission process remains inoperative.

On the other hand, if actual data exists in the data source 11, then a decision of YES is made at step S1, and the processing advances to step S2.

At step S2, the metadata production section 22 produces and outputs start metadata to the metadata/actual data superposition section 23 under the control of the control section 21. In particular, if it is decided by the process at step S1 that actual data exists in the data source 11, then the control section 21 issues an instruction to the metadata production section 22 to produce start metadata for the data source 11. Therefore, the metadata production section 22 produces start metadata and outputs the start metadata to the metadata/actual data superposition section 23.

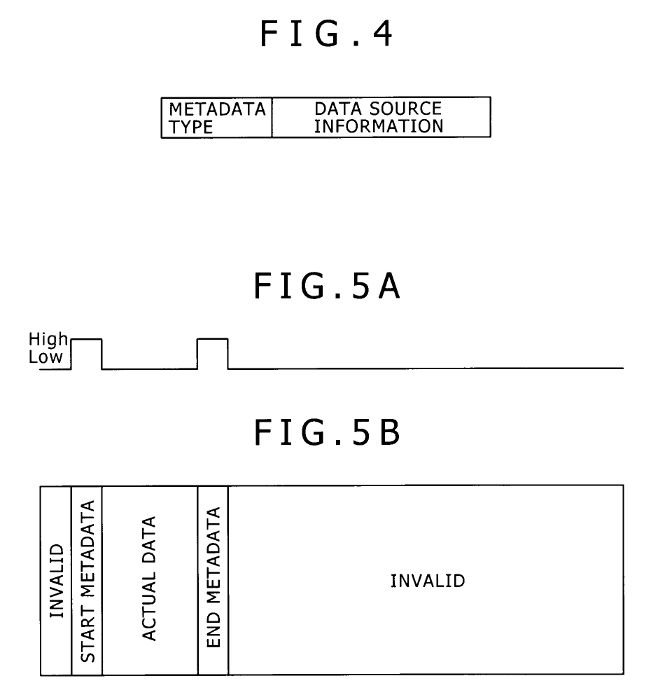

Here, the start metadata is a kind of metadata representative of a start of actual data. The start metadata in the present embodiment may have, for example, a structure illustrated in FIG. 4. Referring to FIG. 4, the start metadata has a structure including a metadata type part and a data source information part for incidental information. The metadata type part accommodates information representative of start metadata. The data source information part accommodates data source information representative of the data source from which the actual data has been outputted. From this prerequisite, in the data transmission process of FIG. 3, information indicative of the data source 11 is accommodated in the data source information part.

At step S3, the metadata/actual data superposition section 23 outputs the start metadata and the metadata flag in the high level state to the data reception apparatus 2 under the control of the control section 21. In particular, the control section 21 issues an instruction to output the start metadata and another instruction to set the output level of the metadata flag to the high level to the metadata/actual data superposition section 23. In response to the instructions, the metadata/actual data superposition section 23 outputs the start metadata to the data reception apparatus 2 through the data bus 41 and outputs the metadata flag in the high level state to the data reception apparatus 2 through the control signal line 42.

At step S4, the metadata/actual data superposition section 23 outputs the actual data and the metadata flag in the low level state to the data reception apparatus 2 under the control of the control section 21. In particular, the control section 21 issues an instruction to output the actual data and another instruction to set the output level of the metadata flag to the low level to the metadata/actual data superposition section 23. In response to the instructions, the metadata/actual data superposition section 23 outputs the actual data to the data reception apparatus 2 through the data bus 41 and outputs the metadata flag in the low level state to the data reception apparatus 2 through the control signal line 42.

At step S5, the control section 21 decides whether or not the actual data ends.

As long as the actual data is outputted from the data source 11, a decision of NO is made at step S5, and the processing returns to step S4 to repeat the processes at the steps beginning with step S4. In other words, as long as actual data is outputted from the data source 11, the loop processes at steps S4 and S5 are repeated. While the processes at step S4 and S5 continue, the actual data continues to be outputted from the data bus 41 and the metadata flag in the low level state continues to be outputted from the control signal line 42.

After the actual data from the data source 11 ends, that is, after the outputting from the data source 11 stops, a decision of YES is made at step S5, and the processing advances to step S6.

At step S6, the metadata production section 22 produces and outputs end metadata to the metadata/actual data superposition section 23 under the control of the control section 21. In particular, if it is decided at step S5 that the actual data ends, then the control section 21 issues an instruction to produce end metadata for the data source 11 to the metadata production section 22. Then, the metadata production section 22 produces and outputs end metadata to the metadata/actual data superposition section 23.

Here, the end metadata is a kind of metadata representative of an end of the actual data. The end metadata in the present embodiment may have, for example, a structure illustrated in FIG. 4. Referring to FIG. 4, the end metadata has a structure including a metadata type part and a data source information part for incidental information. The metadata type part accommodates information representative of the end metadata. The data source information part accommodates data source information representative of the data source from which the actual data has been outputted. From this prerequisite, in the data transmission process of FIG. 3, information indicative of the data source 11 is accommodated in the data source information part.

At step S7, the metadata/actual data superposition section 23 outputs the end metadata and the metadata flag in the high level state to the data reception apparatus 2 under the control of the control section 21. In particular, the control section 21 issues an instruction to output the end metadata and another instruction to set the output level of the metadata flag to the high level to the metadata/actual data superposition section 23. In response to the instructions, the metadata/actual data superposition section 23 outputs the end metadata to the data reception apparatus 2 through the data bus 41 and outputs the metadata flag in the high level state to the data reception apparatus 2 through the control signal line 42.

The data transmission process of FIG. 3 ends therewith.

As the data transmission process of FIG. 3 is executed in this manner, the metadata flag having, for example, such a waveform as illustrated in FIG. 5A is transmitted along the control signal line 42. Meanwhile, the metadata-superposed actual data having such an arrangement configuration as seen in FIG. 5B is transmitted along the data bus 41.

It is to be noted that the term invalid in FIG. 5B represents that no data exists or invalid data exists. Further, the horizontal direction from the left toward the right in FIGS. 5A and 5B indicates the time direction.

Now, an example of a data reception process corresponding to the data transmission process of FIG. 3 is described with reference to FIG. 6. The data reception process of FIG. 6 is carried out where the data source 11 is valid while the data source 12 is invalid and variable length data whose data length is not known is transmitted from the data transmission apparatus 1 to the data reception apparatus 2.

At step S21, the metadata/actual data separation section 31 decides whether or not metadata arrives from the data transmission apparatus 1. In particular, after the metadata/actual data separation section 31 starts a data reception process, it begins to supervise the signal level of the metadata flag transmitted along the control signal line 42.

In a state wherein the signal level of the metadata flag has the low level, the metadata/actual data separation section 31 decides that metadata does not arrive as yet and makes a decision of NO at step S21, and the processing returns to step S21 to repeat the process at step S21.

Thereafter, when the signal level of the metadata flag changes over from the low level to the high level, the metadata/actual data separation section 31 decides that metadata arrives and makes a decision of YES at step S21, and the processing advances to step S22.

At step S22, the metadata interpretation section 32 interprets the contents of the data type part (refer to FIG. 4) of the metadata and decides whether or not a result of the interpretation is the start metadata.

If the interpretation result is any other than the start metadata, then the metadata interpretation section 32 decides that the process at step S21 is a wrong decision and makes a decision of NO at step S22. Thus, the processing returns to step S21 to repeat the processes at the steps beginning with step S21. It is to be noted that, if the interpretation result is any other than the start metadata, then though not illustrated, for example, the data reception apparatus 2 may execute a predetermined error process to compulsorily end the data reception process.

On the other hand, if the interpretation result of the metadata type is the start metadata, then a decision of YES is made at step S22, and the processing advances to step S23.

At step S23, the data distribution section 33 issues a notification of a start of data to the outputting destination.

In particular, where the interpretation result of the metadata type is the start metadata, the metadata interpretation section 32 interprets the contents of the data source information part (refer to FIG. 4) of the metadata. By the interpretation, the data source of the actual data which is to be transmitted following the start metadata is specified.

More particularly, for example, the data reception process of FIG. 6 is a process by the reception side corresponding to the data transmission process of FIG. 3. Therefore, in the data reception process of FIG. 6, the data source information part must accommodate information representative of the data source 11. Accordingly, in the data reception process of FIG. 6, it is specified that the data source of the actual data is the data source 11. Further, in the present embodiment, it is presupposed that the output destination from the data source 11 is the data outputting destination 13. Therefore, it is specified that the outputting destination of the actual data is the data outputting destination 13. Therefore, the metadata interpretation section 32 notifies the data distribution section 33 that the outputting destination of the actual data is the data outputting destination 13. Further, the metadata interpretation section 32 notifies the data outputting destination 13 of a start of data.

At step S24, the metadata/actual data separation section 31 receives actual data from the data transmission apparatus 1.

In particular, as can be recognized also from FIGS. 5A and 5B, the actual data arrives at the data reception apparatus 2 after timing at which the output level of the metadata flag changes from the high level to the low level. Therefore, the metadata/actual data separation section 31 receives the actual data from the data transmission apparatus 1 and outputs the received actual data to the data distribution section 33.

At step S25, the data distribution section 33 outputs the actual data to the data outputting destination 13.

At step S26, the metadata/actual data separation section 31 decides whether or not metadata arrives from the data transmission apparatus 1.

If the signal level of the metadata flag is the low level, then the metadata/actual data separation section 31 decides that metadata does not arrive as yet and makes a decision of NO at step S26, and the processing is returned to step S24 to repeat the processes at the steps beginning with step S24. In particular, as can be recognized from FIGS. 5A and 5B, that the output level of the metadata flag remains the low level signifies that the actual data continues to arrive at the data reception apparatus 2. Therefore, the loop processes at steps S24 to S26 are repeated by the data reception apparatus 2 to receive and output the actual data in the form of streaming data to the data outputting destination 13.

Thereafter, if the signal level of the metadata flag changes over from the high level to the low level, then the metadata/actual data separation section 31 decides that metadata arrives and makes a decision of YES at step S26. Thus, the processing advances to step S27.

At step S27, the metadata interpretation section 32 interprets the contents of the metadata type part (refer to FIG. 4) of the metadata and decides whether or not a result of the interpretation is the end metadata.

If the interpretation result is any other than the end metadata, then the metadata interpretation section 32 decides that the process at step S26 is a wrong decision and makes a decision of NO at step S27. Thus, the processing is returned to step S24 to repeat the processes at the steps beginning with step S24. It is to be noted that, if the interpretation result is any other than the end metadata, then though not illustrated, for example, the data reception apparatus 2 may execute a predetermined error process to compulsorily end the data reception process.

On the other hand, if the interpretation result of the metadata type is the end metadata, then the metadata interpretation section 32 makes a decision of YES at step S27, and the processing advances to step S28.

At step S28, the data distribution section 33 notifies the outputting destination of an end of data.

The data reception process of FIG. 6 ends therewith.

The data transmission process of FIG. 3 and the data reception process of FIG. 6 are such as described above.

Now, an example of the data transmission process and the data reception process where the data source 11 is valid while the data source 12 is invalid and variable length data whose data length is known is transmitted from the data transmission apparatus 1 to the data reception apparatus 2 is described.

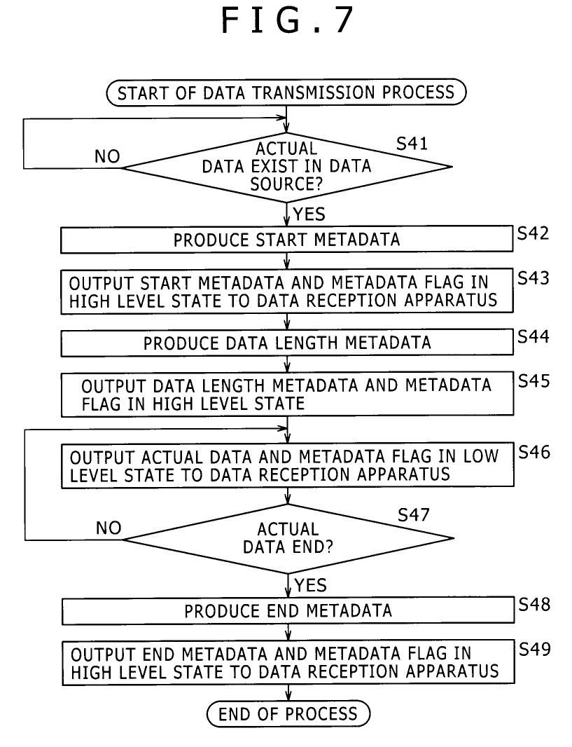

FIG. 7 illustrates an example of the data transmission process in such a case as just described.

Referring to FIG. 7, the control section 21 of the data transmission apparatus 1 decides at step S41 whether or not actual data exists in the data source 11.

If actual data does not exist in the data source 11, then the control section 21 makes a decision of NO at step S41, and the processing returns to step S41 to repeat the process at step S41. In other words, the decision process at step S41 is repeated until a state wherein actual data exists in the data source 11 is established, and the data transmission process remains in a standby state.

On the other hand, if actual data exists in the data source 11, then the control section 21 makes a decision of YES at step S41, and the processing advances to step S42.

At step S42, the metadata production section 22 produces and outputs start metadata to the metadata/actual data superposition section 23 under the control of the control section 21. In particular, if it is decided by the process at step S41 that data exists in the data source 11, then the control section 21 issues an instruction to the metadata production section 22 to produce start metadata for the data source 11. Thus, the metadata production section 22 produces and outputs start metadata to the metadata/actual data superposition section 23.

At step S43, the metadata/actual data superposition section 23 outputs the start metadata and the metadata flag in the high level state to the data reception apparatus 2 under the control of the control section 21. In particular, the control section 21 issues an instruction to output the start metadata and another instruction to set the output level of the metadata flag to the high level to the metadata/actual data superposition section 23. In response to the instructions, the metadata/actual data superposition section 23 outputs the start metadata to the data reception apparatus 2 through the data bus 41 and outputs the metadata flag in the high level state to the data reception apparatus 2 through the control signal line 42.

At step S44, the metadata production section 22 produces and outputs data length metadata to the metadata/actual data superposition section 23 under the control of the control section 21. In particular, the data source 11 notifies the control section 21 of the data length, and in response to the notification of the data length, the control section 21 issues an instruction to the metadata production section 22 to produce data length metadata. Thus, the metadata production section 22 produces and outputs data length metadata to the metadata/actual data superposition section 23.

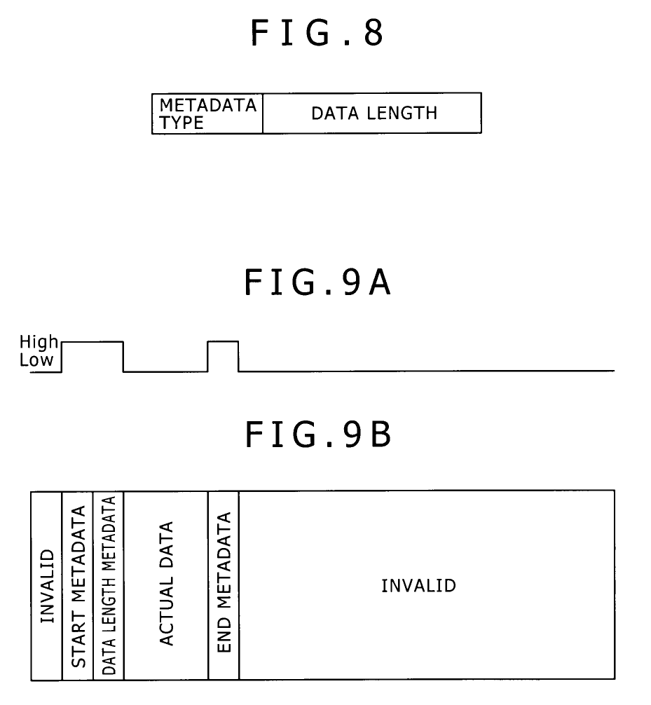

Here, the data length metadata is a kind of metadata which indicates the data length of the actual data. The data length metadata in the present embodiment may have, for example, such a structure as illustrated in FIG. 8. Referring to FIG. 8, the data length metadata has a structure including a metadata type part and a data length information part representative of incidental information. In the metadata type part, information representative of data length metadata is accommodated. In the data length information part, data length information of the actual data is accommodated. From this prerequisite, in the data transmission process, information representative of the data length of data to be transmitted from the data source 11 is accommodated in the data length information part.

At step S45, the metadata/actual data superposition section 23 outputs the data length metadata and the metadata flag in the high level state to the data reception apparatus 2 under the control of the control section 21. In particular, the control section 21 issues an instruction to output the data length metadata and another instruction to maintain the output level of the metadata flag in the high level state to the metadata/actual data superposition section 23. In response to the instructions, the metadata/actual data superposition section 23 outputs the data length metadata to the data reception apparatus 2 through the data bus 41 and continues to output the metadata flag in the high level state to the data reception apparatus 2 through the control signal line 42.

At step S46, the metadata/actual data superposition section 23 outputs the actual data and the metadata flag in the low level state to the data reception apparatus 2 under the control of the control section 21. In particular, the control section 21 issues an instruction to output the actual data and another instruction to set the output level of the metadata flag to the low level to the metadata/actual data superposition section 23. In response to the instructions, the metadata/actual data superposition section 23 outputs the actual data to the data reception apparatus 2 through the data bus 41 and outputs the metadata flag in the low level state to the data reception apparatus 2 through the control signal line 42.

At step S47, the control section 21 decides whether or not the actual data ends.

As long as the actual data continues to be outputted from the data source 11, a decision of NO is made at step S47, and the processing is returned to step S46 to repeat the processes at the steps beginning with step S46. In particular, as long as the actual data continues to be outputted from the data source 11, the loop processes at steps S46 and S47 are repeated. During such repetitions, the actual data continues to be outputted from the data bus 41 and the metadata flag in the low level state continues to be outputted from the control signal line 42.

After the actual data from the data source 11 ends, that is, after the outputting from the data source 11 stops, a decision of YES is made at step S47, and the processing advances to step S48.

At step S48, the metadata production section 22 produces and outputs end metadata to the metadata/actual data superposition section 23 under the control of the control section 21. In particular, if it is decided by the process at step S47 that the actual data ends, then the control section 21 issues an instruction to the metadata production section 22 to produce end metadata for the data source 11. Thus, the metadata production section 22 produces and outputs end metadata to the metadata/actual data superposition section 23.

At step S49, the metadata/actual data superposition section 23 outputs the end metadata and the metadata flag in the high level state to the data reception apparatus 2 under the control of the control section 21. In particular, the control section 21 issues an instruction to output the end metadata and another instruction to set the output level of the metadata flag to the high level to the metadata/actual data superposition section 23. In response to the instructions, the metadata/actual data superposition section 23 outputs the end metadata to the data reception apparatus 2 through the data bus 41 and outputs the metadata flag in the high level state to the data reception apparatus 2 through the control signal line 42.

The data transmission process of FIG. 7 ends therewith.

As the data transmission process of FIG. 7 is executed in such a manner as described above, for example, the metadata flag having such a waveform as shown in FIG. 9A is transmitted to the control signal line 42. Meanwhile, the metadata-superposed actual data having an arrangement configuration illustrated in FIG. 9B is transmitted along the data bus 41.

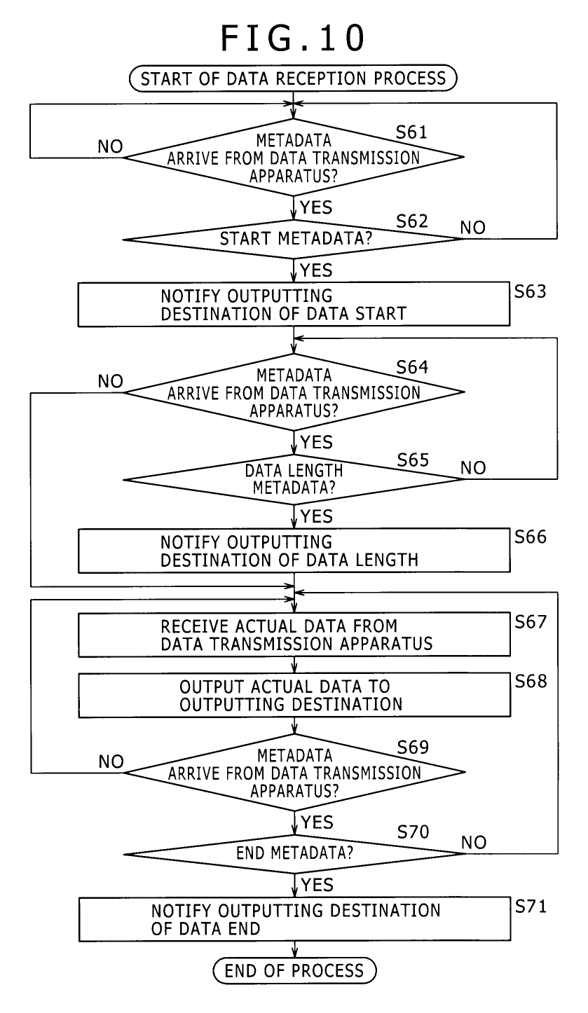

Now, an example of the data reception process corresponding to the data transmission process of FIG. 7 is described with reference to FIG. 10. In particular, the data reception process of FIG. 10 is an example of the data reception process where the data source 11 is valid while the data source 12 is invalid and variable length data whose data length is known is transmitted from the data transmission apparatus 1 to the data reception apparatus 2.

At step S61, the metadata/actual data separation section 31 decides whether or not metadata arrives from the data transmission apparatus 1. In particular, after the data reception process is started, the metadata/actual data separation section 31 begins to supervise the signal level of the metadata flag transmitted along the control signal line 42.

If the signal level of the metadata flag is the low level, then the metadata/actual data separation section 31 decides that metadata does not arrive as yet and makes a decision of NO at step S61, and the processing is returns to step S61 to repeat the process at step S61.

Thereafter, if the signal level of the metadata flag changes over from the low level to the high level, then the metadata/actual data separation section 31 decides that the metadata arrives and makes a decision of YES at step S61, and the processing advances to step S62.

At step S62, the metadata interpretation section 32 interprets the contents of the metadata type part (refer to FIG. 4) of the metadata and decides whether or not a result of the interpretation is the start metadata.

If the interpretation result is any other than the start metadata, then the metadata interpretation section 32 decides that the process at step S61 is a wrong decision and makes a decision of NO at step S62, and the processing is returned to step S61 to repeat the processes at the steps beginning with step S61. It is to be noted that, where the interpretation result is any other than the start metadata, though not illustrated, for example, the data reception apparatus 2 may execute a predetermined error process to compulsorily end the data reception process.

On the other hand, if the interpretation result of the metadata type part is the start metadata, then the metadata interpretation section 32 makes a decision of YES at step S62, and the processing advances to step S63.

At step S63, the data distribution section 33 notifies the outputting destination of a start of the data.

In particular, if the interpretation result of the metadata type part is the start metadata, then the metadata interpretation section 32 interprets the contents of the data source information part (refer to FIG. 4) of the metadata. Consequently, the data source of the actual data which is to be transmitted following the start metadata is specified.

In particular, for example, the data reception process of FIG. 10 is a process of the reception side corresponding to the data transmission process of FIG. 7. Therefore, in the data reception process of FIG. 10, the data source information part must accommodate information representative of the data source 11. Accordingly, in the data reception process of FIG. 10, it is specified that the data source of the actual data is the data source 11. Further, in the present embodiment, it is presupposed that the output destination from the data source 11 is the data outputting destination 13. Therefore, it is specified that the outputting destination of the actual data is the data outputting destination 13. Consequently, the metadata interpretation section 32 notifies the data distribution section 33 that the outputting destination of the actual data is the data outputting destination 13. Further, the metadata interpretation section 32 notifies the data outputting destination 13 of a start of data.

At step S64, the metadata/actual data separation section 31 decides whether or not metadata arrives from the data transmission apparatus 1.

If the signal level of the metadata flag changes over from the high level to the low level, then the metadata/actual data separation section 31 decides that metadata does not arrive any more and makes a decision of NO at step S64, and the processing advances to step S67.

In particular, similarly as in the data reception process where the data length is not known (refer to FIG. 3), a notification of the data length is not issued, and the metadata/actual data separation section 31 receives the actual data from the data transmission apparatus 1 at step S67.

If the signal level of the metadata flag continues to be the high level, then the metadata/actual data separation section 31 decides that metadata arrives and makes a decision of YES at step S64, and the processing advances to step S65.

At step S65, the metadata interpretation section 32 interprets the contents of the metadata type part (refer to FIG. 8) of the metadata and decides whether or not a result of the interpretation is the data length metadata.

If the interpretation result is any other than the data length metadata, then the metadata interpretation section 32 decides that the process at step S64 is a wrong decision and makes a decision of NO at step S65. Consequently, the processing returns to step S64 to repeat the processes at the steps beginning with step S64. It is to be noted that, where the interpretation result is any other than the data length metadata, though not illustrated, for example, the data reception apparatus 2 may execute a predetermined error process to compulsorily end the data reception process.

On the other hand, if the interpretation result of the metadata type part is the data length metadata, then the metadata interpretation section 32 makes a decision of YES at step S65, and the processing advances to step S66.

At step S66, the metadata interpretation section 32 notifies the outputting destination of the data length.

In particular, if the interpretation result of the metadata type part is the data length metadata, then the metadata interpretation section 32 interprets the content of the data length information part (refer to FIG. 8) of the metadata. Consequently, the data length of the actual data which is to be transmitted subsequently from the data transmission apparatus 1 is specified.

At step S67, the metadata/actual data separation section 31 receives the actual data from the data transmission apparatus 1.

In particular, as can be recognized from FIGS. 9A and 9B, the actual data comes to arrive at the data reception apparatus 2 after timing at which the output level of the metadata flag changes from the high level to the low level. Therefore, the metadata/actual data separation section 31 receives the actual data from the data transmission apparatus 1 and outputs the received actual data to the data distribution section 33.

At step S68, the data distribution section 33 outputs the actual data to the data outputting destination 13.

At step S69, the metadata/actual data separation section 31 decides whether or not metadata arrives from the data transmission apparatus 1.

If the signal level of the metadata flag is the low level, then the metadata/actual data separation section 31 decides that metadata does not arrive as yet and makes a decision of NO at step S69, and the processing returns to step S67 to repeat the processes at the steps beginning with step S67. In particular, as can be recognized from FIGS. 9A and 9B, that the output level of the metadata flag maintains the low level state signifies that the actual data continues to arrive at the data reception apparatus 2. Therefore, the loop processes at step S67 to S69 are repeated so that the actual data in the form of streaming data is received by the data reception apparatus 2 and outputted to the data outputting destination 13.

Thereafter, if the signal level of the metadata flag changes over from the low level to the high level, then the metadata/actual data separation section 31 decides that metadata arrives and a decision of YES is made at step S69, and the processing advances to step S70.

At step S70, the metadata interpretation section 32 interprets the contents of the metadata type part (refer to FIG. 4) of the metadata and decides whether or not a result of the interpretation is the end metadata.

If the interpretation result is any other than the end metadata, then the metadata interpretation section 32 decides that the process at step S69 is a wrong process and makes a decision of NO at step S70, and the processing is returned to step S67 to repeat the processes at the steps beginning with step S67. It is to be noted that, if the interpretation result is any other than the end metadata, then thought not illustrated, for example, the data reception apparatus 2 may execute a predetermined process to compulsorily end the data reception process.

On the other hand, if the interpretation result of the metadata type part is the end metadata, then the metadata interpretation section 32 makes a decision of YES at step S70, and the processing advances to step S71.

At step S71, the data distribution section 33 notifies the outputting destination of the end of the data.

The data reception process of FIG. 10 ends therewith.

Now, an example of the data transmission process and the data reception process where first to fourth conditions are applied is described. The first condition is that both the data source 11 and the data source 12 are valid. The second condition is that variable length data is transmitted from the data transmission apparatus 1 to the data reception apparatus 2. The third condition is that the data source 11 outputs non-preferential data and the data source 12 outputs preferential data. Here, where a plurality of data sources are different in preferentiality, actual data outputted from the preferential data source is regarded as preferential data. On the other hand, actual data outputted from the non-preferential data source is regarded as non-preferential data. In this instance, the data transmission apparatus 1 can carry out priority control of outputting the preferential data preferentially to the non-preferential data. The fourth condition is that the data length is not known.

When one of the data sources 11 and 12 does not have data, the data transmission apparatus 1 executes a data transmission process in accordance with the flow chart of FIG. 3. In this instance, the data reception apparatus 2 executes a data reception process in accordance with the flow chart of FIG. 6. This is because that a data source does not have data can be treated equivalently to that the data source is invalid.

Therefore, the following description is given assuming that both of the data sources 11 and 12 have data. More particularly, description is given of an example of a data transmission process and a data reception process in a case wherein, for example, while long data outputted from the data source 11 is transmitted from the data transmission apparatus 1, the data source 12 has short data.

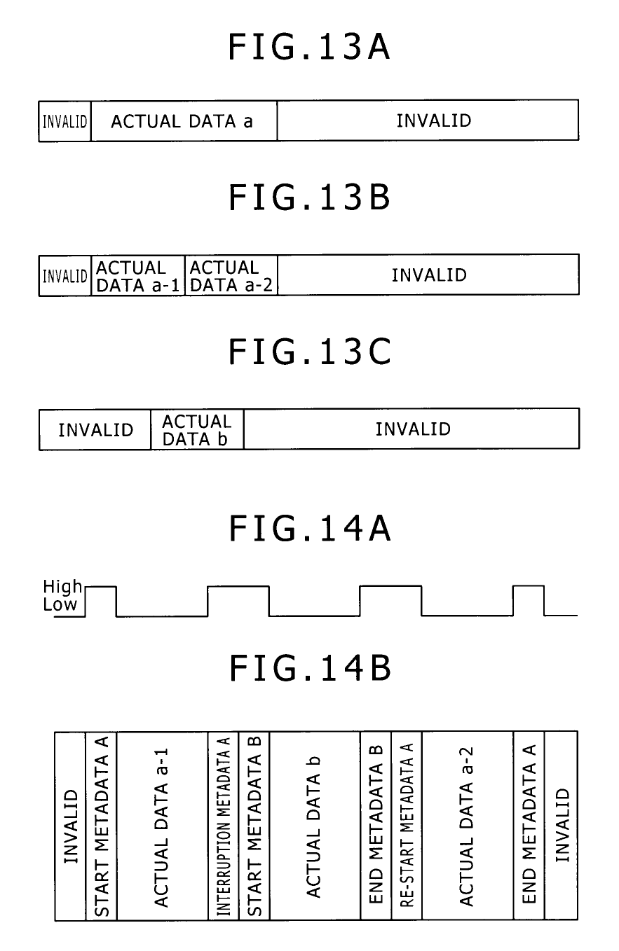

More particularly, a data transmission process and a data reception process in a case wherein actual data a is generated in the data source 11 at timing of FIG. 13A and actual data b is generated in the data source 12 at timing of FIG. 13C are described.

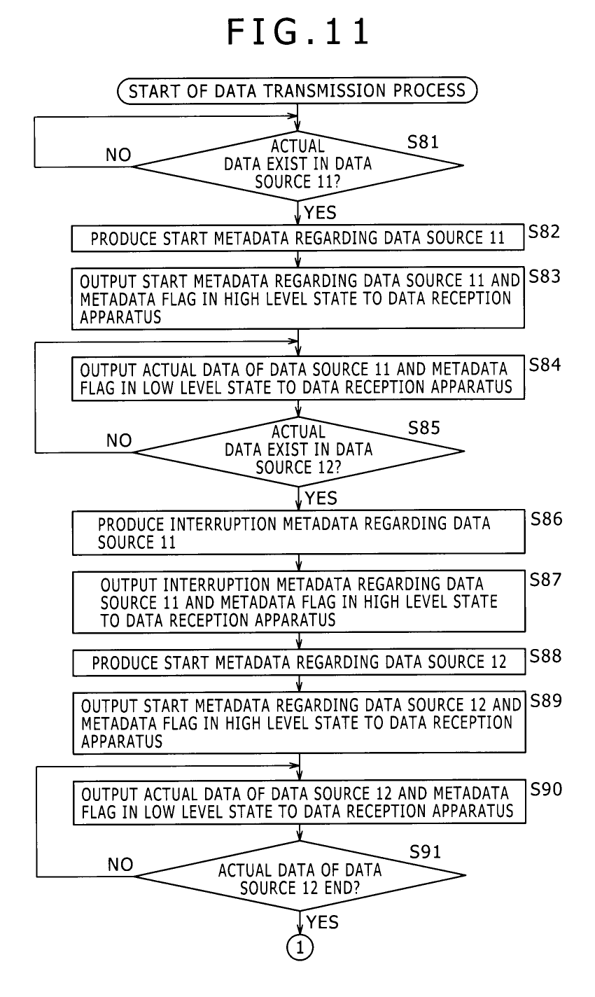

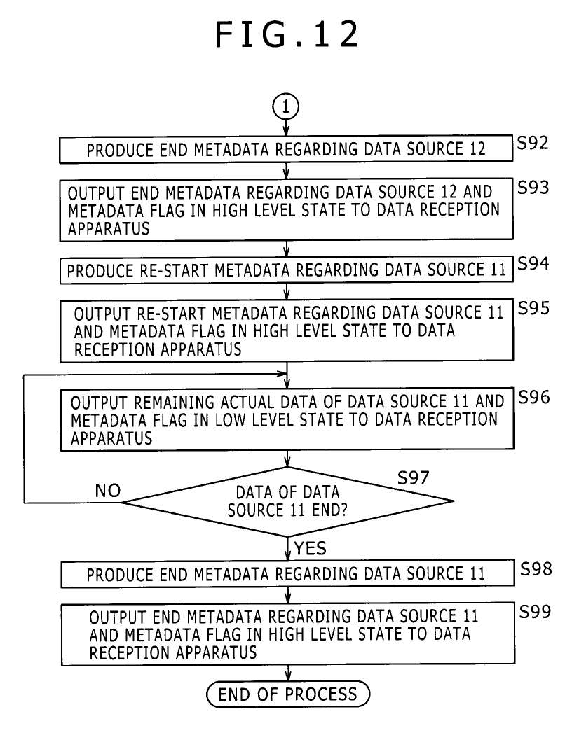

FIGS. 11 and 12 illustrate an example of a data transmission process in such a case as just described.

Referring first to FIG. 11, the control section 21 of the data transmission apparatus 1 decides at step S81 whether or not actual data a exists in the data source 11.

If the actual data a does not exist in the data source 11, then the control section 21 makes a decision of NO at step S81, and the processing returns to step S81 to repeat the process at step S81. In other words, the decision process at step S81 is repeated until a state wherein actual data a exists in the data source 11 is established, and the data transmission process remains in a standby state.

On the other hand, if the actual data a exists in the data source 11, then the control section 21 makes a decision of YES at step S81, and the processing advances to step S82.

At step S82, the metadata production section 22 produces and outputs start metadata regarding the data source 11 to the metadata/actual data superposition section 23 under the control of the control section 21. In particular, if it is decided by the process at step S81 that data exists in the data source 11, then the control section 21 issues an instruction to the metadata production section 22 to produce start metadata for the data source 11. Thus, the metadata production section 22 produces and outputs start metadata to the metadata/actual data superposition section 23.

Here, the start metadata is a kind of metadata representative of a start of actual data. The start metadata in the present embodiment may have, for example, a structure illustrated in FIG. 4. Referring to FIG. 4, the start metadata has a structure including a metadata type part and a data source information part for incidental information. The metadata type part accommodates information representative of start metadata. The data source information part accommodates data source information representative of the data source from which the actual data has been outputted. From this prerequisite, in the data transmission process of FIG. 11, information indicative of the data source 11 is accommodated in the data source information part.

At step S83, the metadata/actual data superposition section 23 outputs the start metadata regarding the data source 11 and the metadata flag in the high level state to the data reception apparatus 2 under the control of the control section 21. In particular, the control section 21 issues an instruction to output the start metadata regarding the data source 11 and another instruction to set the output level of the metadata flag to the high level to the metadata/actual data superposition section 23. In response to the instructions, the metadata/actual data superposition section 23 outputs the start metadata regarding the data source 11 to the data reception apparatus 2 through the data bus 41 and outputs the metadata flag in the high level state to the data reception apparatus 2 through the control signal line 42.

At step S84, the metadata/actual data superposition section 23 outputs the actual data a of the data source 11 and the metadata flag in the low level state to the data reception apparatus 2 under the control of the control section 21. In particular, the control section 21 issues an instruction to output the actual data a and another instruction to set the output level of the metadata flag to the low level to the metadata/actual data superposition section 23. In response to the instructions, the metadata/actual data superposition section 23 outputs the actual data a of the data source 11 to the data reception apparatus 2 through the data bus 41 and outputs the metadata flag in the low level state to the data reception apparatus 2 through the control signal line 42.

At step S85, the control section 21 of the data transmission apparatus 1 decides whether or not the actual data b exists in the data source 12.

If the actual data b does not exist in the data source 12, then the control section 21 makes a decision of NO at step S85, and the processing returns to step S84 to repeat the processes at the steps beginning with step S84. In other words, the decision process at step S85 is repeated until a state wherein the actual data b exists in the data source 12 is established. In other words, the actual data a of the data source 11 continues to be outputted.

On the other hand, when the actual data b exists in the data source 12, a decision of YES is made at step S85, and the processing advances to step S86.

At step S86, the metadata production section 22 produces and outputs interruption metadata regarding the data source 11 to the metadata/actual data superposition section 23 under the control of the control section 21. In particular, the case wherein it is decided by the process at step S85 that the actual data b exists in the data source 12 signifies a case wherein, since the data source 11 is non-preferential and the data source 12 is preferential, it is necessary to interrupt the transmission of the actual data a of the data source 11 and start transmission of the actual data b of the data source 12. Therefore, the control section 21 issues an instruction to produce interruption metadata for the data source 11 to the metadata production section 22 in order to interrupt the transmission of the actual data a of the data source 11. In response to the instruction, the metadata production section 22 produces and outputs interruption metadata to the metadata/actual data superposition section 23.

Here, the interruption metadata is a kind of metadata indicative of interruption of transmission of actual data. The interruption metadata in the present embodiment has, for example, the structure described hereinabove with reference to FIG. 4. In particular, Referring to FIG. 4, the interruption metadata has a structure including a metadata type part and a data source information part for incidental information. The metadata type part accommodates information representative of the interruption metadata. The data source information part accommodates data source information representative of the data source with which the transmission is interrupted. From this prerequisite, in the data transmission process of FIG. 11, information indicative of the data source 11 is accommodated in the data source information part.

At step S87, the metadata/actual data superposition section 23 outputs the interruption metadata regarding the data source 11 and the metadata flag in the high level state to the data reception apparatus 2 under the control of the control section 21. In particular, the control section 21 issues an instruction to output the intermediate metadata regarding the data source 11 and another instruction to set the output level of the metadata flag to the high level to the metadata/actual data superposition section 23. In response to the instructions, the metadata/actual data superposition section 23 interrupts the transmission of the actual data a of the data source 11 and changes over the signal level of the metadata flag from the low level to the high level. Then, the metadata/actual data superposition section 23 starts transmission of the interruption metadata regarding the data source 11. In particular, the metadata/actual data superposition section 23 outputs the interruption metadata regarding the data source 11 to the data reception apparatus 2 through the data bus 41 and outputs the metadata flag in the high level state to the data reception apparatus 2 through the control signal line 42.

Here, a portion of the actual data a illustrated in FIG. 13A which has been transmitted before the transmission interruption is hereinafter referred to as actual data a-1 in conformity with the indication in FIG. 13B, and the remaining part of the actual data a is hereinafter referred to as actual data a-2.

At step S88, the metadata production section 22 produces and outputs start metadata regarding the data source 12 to the metadata/actual data superposition section 23 under the control of the control section 21. In particular, the control section 21 issues an instruction to the metadata production section 22 to produce start metadata for the data source 12. Thus, the metadata production section 22 produces and outputs start metadata regarding the data source 12 to the metadata/actual data superposition section 23.

At step S89, the metadata/actual data superposition section 23 outputs the start metadata regarding the data source 12 and the metadata flag in the high level state to the data reception apparatus 2 under the control of the control section 21. In particular, the control section 21 issues an instruction to output the start metadata regarding the data source 12 and another instruction to maintain the output level of the metadata flag in the high level state to the metadata/actual data superposition section 23. In response to the instructions, the metadata/actual data superposition section 23 outputs the start metadata regarding the data source 12 to the data reception apparatus 2 through the data bus 41 and continues to output the metadata flag in the high level state to the data reception apparatus 2 through the control signal line 42.

At step S90, the metadata/actual data superposition section 23 outputs the actual data b of the data source 12 and the metadata flag in the low level state to the data reception apparatus 2 under the control of the control section 21. In particular, the control section 21 issues an instruction to output the actual data b and another instruction to set the output level of the metadata flag to the low level to the metadata/actual data superposition section 23. In response to the instructions, the metadata/actual data superposition section 23 outputs the actual data b of the data source 12 to the data reception apparatus 2 through the data bus 41 and outputs the metadata flag in the low level state to the data reception apparatus 2 through the control signal line 42.

At step S91, the control section 21 of the data transmission apparatus 1 decides whether or not the actual data ends.

As long as the actual data b continues to be outputted from the data source 12, a decision of NO is made at step S91, and the processing is returned to step S90 to repeat the processes at the steps beginning with step S90. In particular, as long as the actual data b continues to be outputted from the data source 12, the loop processes at steps S90 and S91 are repeated. During such repetitions, the actual data b continues to be outputted from the data bus 41 and the metadata flag in the low level state continues to be outputted from the control signal line 42.

After the actual data b regarding the data source 12 ends, that is, after the outputting from the data source 12 stops, a decision of YES is made at step S91, and the processing advances to step S92 of FIG. 12.

Referring now to FIG. 12, at step S92, the metadata production section 22 produces and outputs end metadata regarding the data source 12 to the metadata/actual data superposition section 23 under the control of the control section 21. In particular, if it is decided by the process at step S91 that the actual data ends, then the control section 21 issues an instruction to the metadata production section 22 to produce end metadata for the data source 12. Thus, the metadata production section 22 produces and outputs end metadata regarding the data source 12 to the metadata/actual data superposition section 23.

At step S93, the metadata/actual data superposition section 23 outputs the end metadata regarding the data source 12 and the metadata flag in the high level state to the data reception apparatus 2 under the control of the control section 21. In particular, the control section 21 issues an instruction to output the end metadata regarding the data source 12 and another instruction to set the output level of the metadata flag to the high level to the metadata/actual data superposition section 23. In response to the instructions, the metadata/actual data superposition section 23 outputs the end metadata regarding the data source 12 to the data reception apparatus 2 through the data bus 41 and outputs the metadata flag in the high level state to the data reception apparatus 2 through the control signal line 42.

At step S94, the metadata production section 22 produces and outputs re-start metadata regarding the data source 11 to the metadata/actual data superposition section 23 under the control of the control section 21. The control section 21 issues an instruction to produce re-start metadata for the data source 11 to the metadata production section 22. Consequently, the metadata production section 22 produces and outputs re-start metadata regarding the data source 11 to the metadata/actual data superposition section 23.

Here, the re-start metadata is a kind of metadata representative of a re-start of actual data. The re-start metadata in the present embodiment may have, for example, a structure illustrated in FIG. 4. Referring to FIG. 4, the re-start metadata has a structure including a metadata type part and a data source information part for incidental information. The metadata type part accommodates information representative of re-start metadata. The data source information part accommodates data source information representative of the data source to which transmission is re-started. From this prerequisite, in the data transmission process of FIG. 12, information indicative of the data source 11 is accommodated in the data source information part.

At step S95, the metadata/actual data superposition section 23 outputs the re-start metadata regarding the data source 11 and the metadata flag in the high level state to the data reception apparatus 2 under the control of the control section 21. In particular, the control section 21 issues an instruction to output the re-start metadata regarding the data source 11 and another instruction to maintain the high level of the output level of the metadata flag to the metadata/actual data superposition section 23. In response to the instructions, the metadata/actual data superposition section 23 outputs the re-start metadata regarding the data source 11 to the data reception apparatus 2 through the data bus 41 and continues to output the metadata flag in the high level state to the data reception apparatus 2 through the control signal line 42.

At step S96, the metadata/actual data superposition section 23 outputs the remaining actual data a-2 of the data source 11 and the metadata flag in the low level state to the data reception apparatus 2 under the control of the control section 21. In particular, the control section 21 issues an instruction to output the actual data a-2 of FIG. 13B and another instruction to set the output level of the metadata flag to the low level to the metadata/actual data superposition section 23. In response to the instructions, the metadata/actual data superposition section 23 outputs the remaining actual data a-2 of the data source 11 to the data reception apparatus 2 through the data bus 41 and outputs the metadata flag in the low level state to the data reception apparatus 2 through the data reception apparatus 2.

At step S97, the control section 21 decides whether or not the actual data of the data source 11 ends.

As long as the actual data a-2 is outputted from the data source 11, a decision of NO is made at step S97, and the processing returns to step S96 to repeat the processes at the steps beginning with step S96. In other words, as long as the actual data a-2 is outputted from the data source 11, the loop processes at steps S96 and S97 are repeated. While the processes at step S96 and S97 continue, the actual data a-2 continues to be outputted from the data bus 41 and the metadata flag in the low level state continues to be outputted from the control signal line 42.

After the actual data a-2 from the data source 11 ends, that is, after the actual data a-2 is outputted from the data source 11 completely and the outputting from the data source 11 stops, a decision of YES is made at step S97, and the processing advances to step S98.

At step S98, the metadata production section 22 produces and outputs end metadata regarding the data source 11 to the metadata/actual data superposition section 23 under the control of the control section 21. In particular, if it is decided by the process at step S97 that the actual data ends, then the control section 21 issues an instruction to produce end metadata for the data source 11 to the metadata production section 22. Then, the metadata production section 22 produces and outputs end metadata regarding the data source 11 to the metadata/actual data superposition section 23.

At step S99, the metadata/actual data superposition section 23 outputs the end metadata regarding the data source 11 and the metadata flag in the high level state to the data reception apparatus 2 under the control of the control section 21. In particular, the control section 21 issues an instruction to output the end metadata regarding the data source 11 and another instruction to set the output level of the metadata flag to the high level to the metadata/actual data superposition section 23. In response to the instructions, the metadata/actual data superposition section 23 outputs the end metadata regarding the data source 11 to the data reception apparatus 2 through the data bus 41 and outputs the metadata flag in the high level state to the data reception apparatus 2 through the control signal line 42.

The data transmission process of FIGS. 11 and 12 ends therewith.

As the data transmission process of FIGS. 11 and 12 is executed in this manner, the metadata flag having, for example, such a waveform as illustrated in FIG. 14A is transmitted along the control signal line 42. Meanwhile, the metadata-superposed actual data having such an arrangement configuration as seen in FIG. 14B is transmitted along the data bus 41.

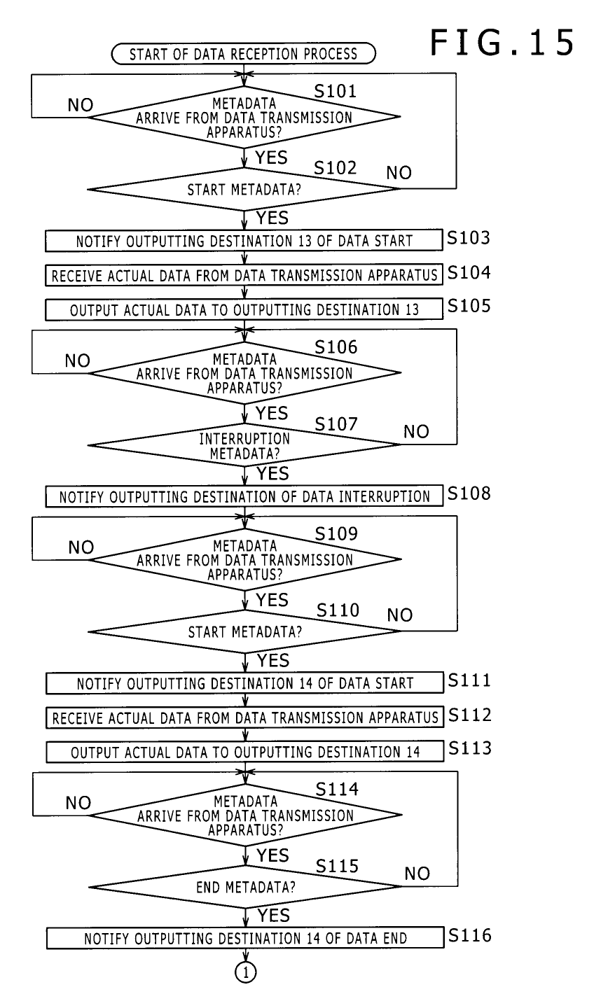

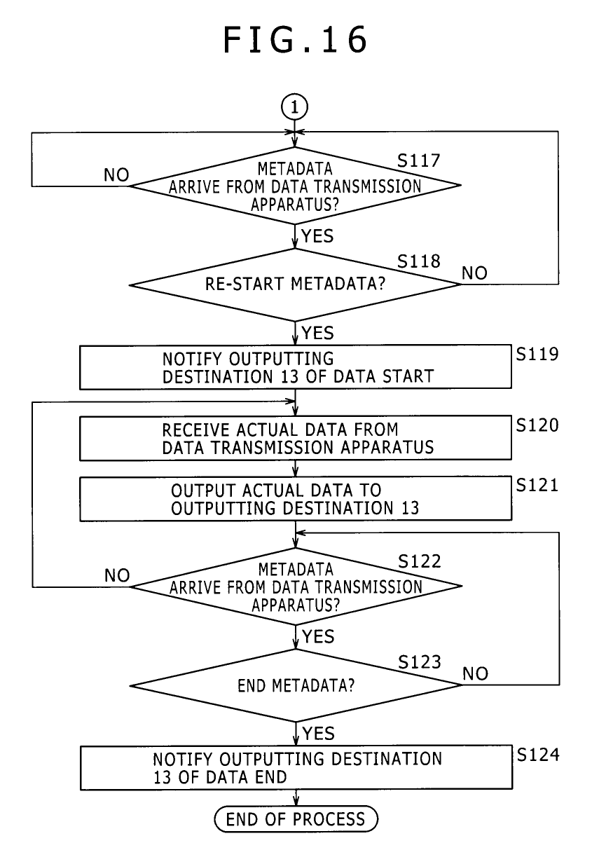

Now, an example of a data reception process corresponding to the data transmission process of FIGS. 11 and 12 is described with reference to FIGS. 15 and 16. The data reception process of FIG. 15 is carried out in such conditions that both of the data sources 11 and 12 are valid and variable length data is transmitted from the data transmission apparatus 1 to the data reception apparatus 2, that the data source 11 outputs non-preferential data and the data source 12 outputs preferential data, that the data length is not known, and that short data exists in the data source 12 during transmission of long data outputted from the data source 11 by the data transmission apparatus 1.

At step S101, the metadata/actual data separation section 31 decides whether or not metadata arrives from the data transmission apparatus 1. In particular, after the metadata/actual data separation section 31 starts a data reception process, it begins to supervise the signal level of the metadata flag transmitted along the control signal line 42.

In a state wherein the signal level of the metadata flag has the low level, the metadata/actual data separation section 31 decides that metadata does not arrive as yet and makes a decision of NO at step S101, and the processing returns to step S101 to repeat the process at step S101.

Thereafter, when the signal level of the metadata flag changes over from the low level to the high level, the metadata/actual data separation section 31 decides that metadata arrives and makes a decision of YES at step S101, and the processing advances to step S102.

At step S102, the metadata interpretation section 32 interprets the contents of the data type part (refer to FIG. 4) of the metadata and decides whether or not a result of the interpretation is the start metadata.

If the interpretation result is any other than the start metadata, then the metadata interpretation section 32 decides that the process at step S101 is a wrong decision and makes a decision of NO at step S102. Thus, the processing returns to step S101 to repeat the processes at the steps beginning with step S101. It is to be noted that, if the interpretation result is any other than the start metadata, then though not illustrated, for example, the data reception apparatus 2 may execute a predetermined error process to compulsorily end the data reception process.

On the other hand, if the interpretation result of the metadata type is the start metadata, then a decision of YES is made at step S102, and the processing advances to step S103.

At step S103, the data distribution section 33 issues a notification of a start of data to the outputting destination.

In particular, where the interpretation result of the metadata type is the start metadata, the metadata interpretation section 32 interprets the contents of the data source information part (refer to FIG. 4) of the metadata. By the interpretation, the data source of the actual data a-1 which is to be transmitted following the start metadata is specified.

More particularly, for example, the data reception process of FIGS. 15 and 16 is a process by the reception side corresponding to the data transmission process of FIGS. 11 and 12. Therefore, at step S103, the data source information part must accommodate information representative of the data source 11. Accordingly, at step S103, it is specified that the data source of the actual data a-1 is the data source 11. Further, in the present embodiment, it is presupposed that the output destination from the data source 11 is the data outputting destination 13. Therefore, it is specified that the outputting destination of the actual data a-1 is the data outputting destination 13. Therefore, the metadata interpretation section 32 notifies the data distribution section 33 that the outputting destination of the actual data a-1 is the data outputting destination 13. Further, the metadata interpretation section 32 notifies the data outputting destination 13 of a start of data.

At step S104, the metadata/actual data separation section 31 receives the actual data a-1 from the data transmission apparatus 1.

In particular, as can be recognized also from FIGS. 14A and 14B, the actual data a-1 arrives at the data reception apparatus 2 after timing at which the output level of the metadata flag changes from the high level to the low level. Therefore, the metadata/actual data separation section 31 receives the actual data a-1 from the data transmission apparatus 1 and outputs the received actual data a-1 to the data distribution section 33.

At step S105, the data distribution section 33 outputs the actual data a-1 to the data outputting destination 13.

At step S106, the metadata/actual data separation section 31 decides whether or not metadata arrives from the data transmission apparatus 1.

If the signal level of the metadata flag is the low level, then the metadata/actual data separation section 31 decides that metadata does not arrive as yet and makes a decision of NO at step S106, and the processing is returned to step S104 to repeat the processes at the steps beginning with step S104. In particular, as can be recognized from FIGS. 14A and 14B, that the output level of the metadata flag remains the low level signifies that the actual data continues to arrive at the data reception apparatus 2. Therefore, the loop processes at steps S104 to S106 are repeated by the data reception apparatus 2 to receive and output the actual data in the form of streaming data to the data outputting destination 13.

Thereafter, if the signal level of the metadata flag changes over from the low level to the high level, then the metadata/actual data separation section 31 decides that metadata arrives and makes a decision of YES at step S106. Thus, the processing advances to step S107.

At step S107, the metadata interpretation section 32 interprets the contents of the metadata type part (refer to FIG. 4) of the metadata and decides whether or not a result of the interpretation is the interruption metadata.

If the interpretation result is any other than the interruption metadata, then the metadata interpretation section 32 decides that the process at step S106 is a wrong decision and makes a decision of NO at step S107. Thus, the processing is returned to step S106 to repeat the processes at the steps beginning with step S106. It is to be noted that, if the interpretation result is any other than the interruption metadata, then though not illustrated, for example, the data reception apparatus 2 may execute a predetermined error process to compulsorily end the data reception process.

On the other hand, if the interpretation result of the metadata type is the interruption metadata, then the metadata interpretation section 32 makes a decision of YES at step S107, and the processing advances to step S108.

At step S108, the data distribution section 33 notifies the outputting destination of an interruption of data.

In particular, if the interpretation result of the metadata type part is the interruption metadata, then the metadata interpretation section 32 interprets the contents of the data source information part (refer to FIG. 4) of the metadata.

In particular, for example, the data reception process of FIGS. 15 and 16 is a process of the reception side corresponding to the data transmission process of FIGS. 11 and 12. Therefore, at step S108, the data source information part must accommodate information representative of the data source 11. Accordingly, at step S108, it is specified that the data source of the actual data a-1 is the data source 11. Further, in the present embodiment, it is presupposed that the output destination from the data source 11 is the data outputting destination 13. Therefore, it is specified that the outputting destination of the actual data a-1 is the data outputting destination 13. Consequently, the metadata interpretation section 32 notifies the data distribution section 33 that the outputting destination of the actual data a-1 is the data outputting destination 13. Further, the metadata interpretation section 32 notifies the data outputting destination 13 of an interruption of data.

At step S109, the metadata/actual data separation section 31 decides whether or not metadata arrives from the data transmission apparatus 1.

If it is assumed that the signal level of the metadata flag changes over from the high level to the low level, then the metadata/actual data separation section 31 decides that metadata does not arrive as yet and makes a decision of NO at step S109, and the processing returns to step S109 to repeat the process at step S109.

On the other hand, when the signal level of the metadata flag maintains the high level state or when the signal level of the metadata flag changes over from the low level to the high level, the metadata/actual data separation section 31 decides that some metadata arrives and makes a decision of YES at step S109, and the processing advances to step S110.

At step S110, the metadata interpretation section 32 interprets the contents of the data type part (refer to FIG. 4) of the metadata and decides whether or not a result of the interpretation is the start metadata.

If the interpretation result is any other than the start metadata, then the metadata interpretation section 32 decides that the process at step S109 is a wrong decision and makes a decision of NO at step S110. Thus, the processing returns to step S109 to repeat the processes at the steps beginning with step S109. It is to be noted that, if the interpretation result is any other than the start metadata, then though not illustrated, for example, the data reception apparatus 2 may execute a predetermined error process to compulsorily end the data reception process.

On the other hand, if the interpretation result of the metadata type is the start metadata, then a decision of YES is made at step S110, and the processing advances to step S111.

At step S111, the data distribution section 33 issues a notification of a start of data to the outputting destination.

In particular, where the interpretation result of the metadata type is the start metadata, the metadata interpretation section 32 interprets the contents of the data source information part (refer to FIG. 4) of the metadata. By the interpretation, the data source of the actual data b which is to be transmitted following the start metadata is specified.

More particularly, for example, the data reception process of FIGS. 15 and 16 is a process by the reception side corresponding to the data transmission process of FIGS. 11 and 12. Therefore, at step S111, the data source information part must accommodate information representative of the data source 12. Accordingly, at step S111, it is specified that the data source of the actual data b is the data source 12. Further, in the present embodiment, it is presupposed that the output destination from the data source 12 is the data outputting destination 14. Therefore, it is specified that the outputting destination of the actual data b is the data outputting destination 14. Therefore, the metadata interpretation section 32 notifies the data distribution section 33 that the outputting destination of the actual data b is the data outputting destination 14. Further, the metadata interpretation section 32 notifies the data outputting destination 14 of a start of data.

At step S112, the metadata/actual data separation section 31 receives the actual data b from the data transmission apparatus 1.

In particular, as can be recognized also from FIGS. 14A and 14B, the actual data b arrives at the data reception apparatus 2 after timing at which the output level of the metadata flag changes from the high level to the low level. Therefore, the metadata/actual data separation section 31 receives the actual data b from the data transmission apparatus 1 and outputs the received actual data b to the data distribution section 33.

At step S113, the data distribution section 33 outputs the actual data b to the data outputting destination 14.

At step S114, the metadata/actual data separation section 31 decides whether or not metadata arrives from the data transmission apparatus 1.

If the signal level of the metadata flag is the low level, then the metadata/actual data separation section 31 decides that metadata does not arrive as yet and makes a decision of NO at step S114, and the processing is returned to step S112 to repeat the processes at the steps beginning with step S112. In particular, as can be recognized from FIGS. 14A and 14B, that the output level of the metadata flag remains the low level signifies that the actual data continues to arrive at the data reception apparatus 2. Therefore, the loop processes at steps S112 to S114 are repeated by the data reception apparatus 2 to receive and output the actual data in the form of streaming data to the data outputting destination 14.

Thereafter, if the signal level of the metadata flag changes over from the low level to the high level, then the metadata/actual data separation section 31 decides that metadata arrives and makes a decision of YES at step S114. Thus, the processing advances to step S115.

At step S115, the metadata interpretation section 32 interprets the contents of the metadata type part (refer to FIG. 4) of the metadata and decides whether or not a result of the interpretation is the end metadata.

If the interpretation result is any other than the end metadata, then the metadata interpretation section 32 decides that the process at step S114 is a wrong decision and makes a decision of NO at step S115. Thus, the processing is returned to step S114 to repeat the processes at the steps beginning with step S114. It is to be noted that, if the interpretation result is any other than the end metadata, then though not illustrated, for example, the data reception apparatus 2 may execute a predetermined error process to compulsorily end the data reception process.

On the other hand, if the interpretation result of the metadata type is the end metadata, then the metadata interpretation section 32 makes a decision of YES at step S115, and the processing advances to step S116.

At step S116, the data distribution section 33 notifies the outputting destination 14 of an end of data.

At step S117, the metadata/actual data separation section 31 decides whether or not metadata arrives from the data transmission apparatus 1.

If it is assumed that the signal level of the metadata flag changes over from the high level to the low level, then the metadata/actual data separation section 31 decides that metadata does not arrive as yet and makes a decision of NO at step S117, and the processing returns to step S117 to repeat the process at step S117.

On the other hand, when the signal level of the metadata flag maintains the high level state or when the signal level of the metadata flag changes over from the low level to the high level, the metadata/actual data separation section 31 decides that some metadata arrives and makes a decision of YES at step S117, and the processing advances to step S118.

At step S118, the metadata interpretation section 32 interprets the contents of the data type part (refer to FIG. 4) of the metadata and decides whether or not a result of the interpretation is the re-start metadata.

If the interpretation result is any other than the re-start metadata, then the metadata interpretation section 32 decides that the process at step S117 is a wrong decision and makes a decision of NO at step S118. Thus, the processing returns to step S117 to repeat the processes at the steps beginning with step S117. It is to be noted that, if the interpretation result is any other than the re-start metadata, then though not illustrated, for example, the data reception apparatus 2 may execute a predetermined error process to compulsorily end the data reception process.

On the other hand, if the interpretation result of the metadata type is the re-start metadata, then a decision of YES is made at step S118, and the processing advances to step S119.

At step S119, the data distribution section 33 issues a notification of a start of data to the outputting destination.

In particular, where the interpretation result of the metadata type is the re-start metadata, the metadata interpretation section 32 interprets the contents of the data source information part (refer to FIG. 4) of the metadata. By the interpretation, the data source of the actual data a-2 which is to be transmitted following the re-start metadata is specified.

More particularly, for example, the data reception process of FIGS. 15 and 16 is a process by the reception side corresponding to the data transmission process of FIGS. 11 and 12. Therefore, at step S119, the data source information part must accommodate information representative of the data source 11. Accordingly, at step S119, it is specified that the data source of the actual data a-2 is the data source 11. Further, in the present embodiment, it is presupposed that the output destination from the data source 11 is the data outputting destination 13. Therefore, it is specified that the outputting destination of the actual data a-2 is the data outputting destination 13. Therefore, the metadata interpretation section 32 notifies the data distribution section 33 that the outputting destination of the actual data a-2 is the data outputting destination 13. Further, the metadata interpretation section 32 notifies the data outputting destination 14 of a re-start of data.

At step S120, the metadata/actual data separation section 31 receives the actual data from the data transmission apparatus 1.

In particular, as can be recognized also from FIGS. 14A and 14B, the actual data a-2 arrives at the data reception apparatus 2 after timing at which the output level of the metadata flag changes from the high level to the low level. Therefore, the metadata/actual data separation section 31 receives the actual data a-2 from the data transmission apparatus 1 and outputs the received actual data a-2 to the data distribution section 33.

At step S121, the data distribution section 33 outputs the actual data a-2 to the data outputting destination 13.

At step S122, the metadata/actual data separation section 31 decides whether or not metadata arrives from the data transmission apparatus 1.

If the signal level of the metadata flag is the low level, then the metadata/actual data separation section 31 decides that metadata does not arrive as yet and makes a decision of NO at step S122, and the processing is returned to step S120 to repeat the processes at the steps beginning with step S120. In particular, as can be recognized from FIGS. 14A and 14B, that the output level of the metadata flag remains the low level signifies that the actual data a-2 continues to arrive at the data reception apparatus 2. Therefore, the loop processes at steps S120 to S122 are repeated by the data reception apparatus 2 to receive and output the actual data in the form of streaming data to the data outputting destination 13.

Thereafter, if the signal level of the metadata flag changes over from the low level to the high level, then the metadata/actual data separation section 31 decides that metadata arrives and makes a decision of YES at step S122. Thus, the processing advances to step S123.

At step S123, the metadata interpretation section 32 interprets the contents of the metadata type part (refer to FIG. 4) of the metadata and decides whether or not a result of the interpretation is the end metadata.

If the interpretation result is any other than the end metadata, then the metadata interpretation section 32 decides that the process at step S122 is a wrong decision and makes a decision of NO at step S123. Thus, the processing is returned to step S122 to repeat the processes at the steps beginning with step S122. It is to be noted that, if the interpretation result is any other than the end metadata, then though not illustrated, for example, the data reception apparatus 2 may execute a predetermined error process to compulsorily end the data reception process.

On the other hand, if the interpretation result of the metadata type is the end metadata, then the metadata interpretation section 32 makes a decision of YES at step S123, and the processing advances to step S124.

At step S124, the data distribution section 33 notifies the outputting destination of an end of data.

The data reception process of FIGS. 15 and 16 ends therewith.

The data transmission process of FIGS. 11 and 12 and the data reception process of FIGS. 15 and 16 are executed in such a manner as described above.

Now, an example of the data transmission process and the data reception process where first to fourth conditions are applied is described. The first condition is that both the data source 11 and the data source 12 are valid. The second condition is that variable length data is transmitted time-divisionally from the data transmission apparatus 1 to the data reception apparatus 2. The third condition is that the data source 11 and the data source 12 are equal in preferentiality. The fourth condition is that the data length is not known.

When one of the data sources 11 and 12 does not have data, the data transmission apparatus 1 executes a data transmission process in accordance with the flow chart of FIG. 3. In this instance, the data reception apparatus 2 executes a data reception process in accordance with the flow chart of FIG. 6. This is because that a data source does not have data can be treated equivalently to that the data source is invalid.

Therefore, the following description is given with an assumption that both of the data sources 11 and 12 have data.

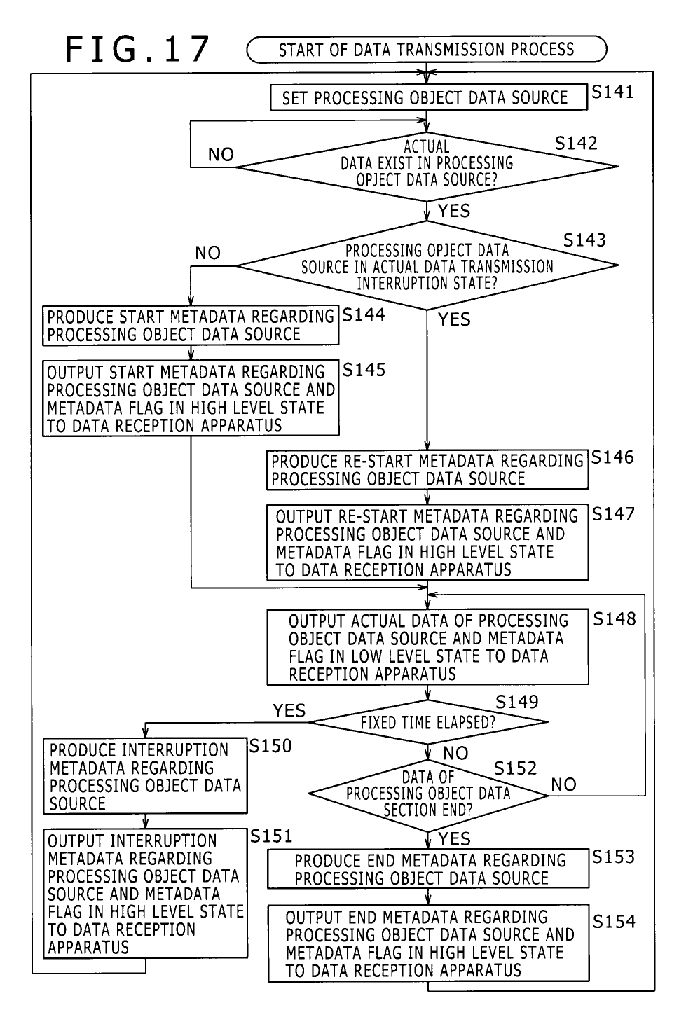

FIG. 17 illustrates an example of a data transmission process in such a case as just described.

Referring to FIG. 17, the control section 21 of the data transmission apparatus 1 sets a processing object data source at step S141.

Although the setting method of the processing object data source is not restricted particularly, it is assumed here that the data source 11 and the data source 12 are set alternately as a processing object data source. Further, it is assumed that initial setting is carried out such that one of the data source 11 and the data source 12 in which data is generated first is set as a processing object data source.

At step S142, the control section 21 decides whether or not actual data exists in the processing object data source.

If actual data does not exist in the processing object data source, then the control section 21 makes a decision of NO at step S142, and the processing returns to step S142 to repeat the process at step S142. In other words, the decision process at step S142 is repeated until a state wherein actual data exists in the processing object data source is established, and the data transmission process remains in a standby state. It is to be noted, however, that, in the present embodiment, since data is transmitted time-divisionally, if a state wherein actual data exists in the processing object data source is not established for more than a fixed period of time, then the processing object data source may be changed over compulsorily.

On the other hand, if actual data exists in the processing object data source, then the control section 21 makes a decision of YES at step S142, and the processing advances to step S143.

At step S143, the control section 21 decides whether or not the processing object data source is in an actual data transmission interruption state.

Here, the “processing object data source is in an actual data transmission interruption state” signifies a state wherein, where the processing object data source has been set as a preceding processing object data source, interruption metadata is outputted by a process at step S151 hereinafter described.

If the processing object data source is not in an actual data transmission interruption state, that is, if end metadata is outputted by a process at step S154 hereinafter described where the processing object data source has been set as a processing object data source in the preceding cycle, then the control section 21 makes a decision of NO at step S143, and the processing advances to step S144.

At step S144, the metadata production section 22 produces start metadata regarding the processing object data source under the control of the control section 21. In particular, the metadata production section 22 produces metadata which has the structure of FIG. 4 and wherein information representative of the start metadata is accommodated in the metadata type part while information representative of the processing object data source is accommodated in the data source information part. The produced start metadata is outputted to the metadata/actual data superposition section 23, and the processing advances to step S145.

At step S145, the metadata/actual data superposition section 23 outputs the start metadata regarding the processing object data source and the metadata flag in the high level state to the data reception apparatus 2 under the control of the control section 21. In particular, the metadata/actual data superposition section 23 outputs the start metadata regarding the processing object data source to the data reception apparatus 2 through the data bus 41 and outputs the metadata flag in the high level state to the data reception apparatus 2 through the control signal line 42. Then, the processing advances to step S148. However, processes at the steps beginning with step S148 are hereinafter described.

On the other hand, if it is decided at step S143 that the processing object data source is in an actual data transmission interruption state, then the processing advances to step S146.

At step S146, the metadata production section 22 produces re-start metadata regarding the processing object data source under the control of the control section 21. In particular, the metadata production section 22 produces metadata which has the structure of FIG. 4 and wherein information representative of the re-start metadata is accommodated in the metadata type part while information representative of the processing object data source is accommodated in the data source information part. The produced re-start metadata is outputted to the metadata/actual data superposition section 23, and the processing advances to step S147.

At step S147, the metadata/actual data superposition section 23 outputs the re-start metadata regarding the processing object data source and the metadata flag in the high level state to the data reception apparatus 2 under the control of the control section 21. In particular, the metadata/actual data superposition section 23 outputs the re-start metadata regarding the processing object data source to the data reception apparatus 2 through the data bus 41 and outputs the metadata flag in the high level state to the data reception apparatus 2 through the control signal line 42. Then, the processing advances to step S148.

At step S148, the metadata/actual data superposition section 23 outputs the actual data of the processing object data source and the metadata flag in the low level state to the data reception apparatus 2 under the control of the control section 21. In particular, the metadata/actual data superposition section 23 outputs the actual data of the processing object data source to the data reception apparatus 2 through the data bus 41 and outputs the metadata flag in the low level state to the data reception apparatus 2 through the control signal line 42.

At step S149, the control section 21 decides whether or not fixed time elapses.

If the fixed time does not elapse, then the control section 21 makes a decision of NO at step S149, and the processing advances to step S152.

At step S152, the control section 21 decides whether or not data of the processing object data source ends.

If data of the processing object data source does not end as yet, then the control section 21 makes a decision of NO at step S152, and the processing returns to the step S148 to repeat the processes at the steps beginning with step S148. In particular, the loop processes at steps S148, S149 and S152 are repeated until the fixed time elapses or until the data in the processing object data source ends, and the actual data of the processing object data source and the metadata flag in the low level state continue to be outputted to the data reception apparatus 2. In this manner, the fixed time in the process at step S149 is a period of time within which data is transmitted time-divisionally.

Thereafter, if the fixed time elapses in the state wherein the data of the processing object data source does not end, then the control section 21 makes a decision of YES at step S149, and the processing advances to step S150.

At step S150, the metadata production section 22 produces and outputs interruption metadata regarding the processing object data source to the metadata/actual data superposition section 23 under the control of the control section 21. In particular, the metadata production section 22 produces metadata which has the structure of FIG. 4 and wherein information representative of the interruption metadata is accommodated in the metadata type part while information representative of the processing object data source is accommodated in the data source information part. The produced interruption metadata is outputted to the metadata/actual data superposition section 23, and the processing advances to step S151.

At step S151, the metadata/actual data superposition section 23 outputs the interruption metadata regarding the processing object data source and the metadata flag in the high level state to the data reception apparatus 2 under the control of the control section 21. In particular, the transmission of the actual data of the processing object data source is interrupted and the signal level of the metadata flag is changed over from the low level to the high level. Then, transmission of the interruption metadata is started.

Thereafter, the processing is returned to step S141 to repeat the processes at the steps beginning with step S141. In particular, that one of the first and second data sources 11 and 12 which has not been the processing object data source is newly set as a processing object data source. Then, the processes at the steps beginning with step S142 are carried out for the new processing object data source.

On the other hand, if the loop processes at steps S148, S149 and S152 are repeated after the re-start metadata is outputted by the process at step S147 and actual data of the processing object data source and the metadata flag in the low level state continue to be outputted to the data reception apparatus 2, then the following process is carried out. In particular, in this instance, after the actual data of the processing object data source ends, a decision of YES is made at step S152 and the processing advances to step S153.

At step S153, the metadata production section 22 produces and outputs end metadata regarding the processing object data source to the metadata/actual data superposition section 23 under the control of the control section 21. In particular, the metadata production section 22 produces metadata which has the structure of FIG. 4 and wherein information representative of the end metadata is accommodated in the metadata type part while information representative of the processing object data source is accommodated in the data source information part. The produced end metadata is outputted to the metadata/actual data superposition section 23, and the processing advances to step S154.

At step S154, the metadata/actual data superposition section 23 outputs the end metadata regarding the processing object data source and the metadata flag in the high level state to the data reception apparatus 2 under the control of the control section 21. In particular, the transmission of actual data of the processing object data source ends and the signal level of the metadata flag is changed over from the low level to the high level. Then, transmission of the end metadata is started.

Thereafter, the processing is returned to step S141 to repeat the processes at the steps beginning with step S141. In particular, that one of the first and second data sources 11 and 12 which has not been the processing object data source is newly set as the processing object data source. Then, the processes at the steps beginning with step S142 are carried out for the new processing object data source.

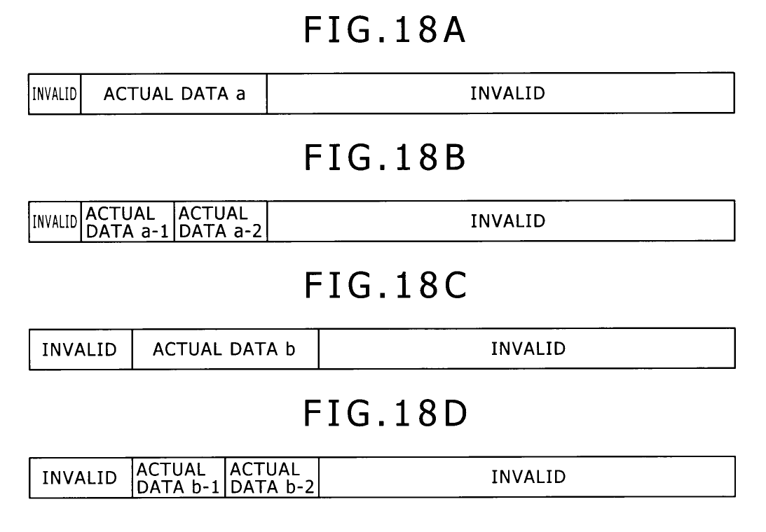

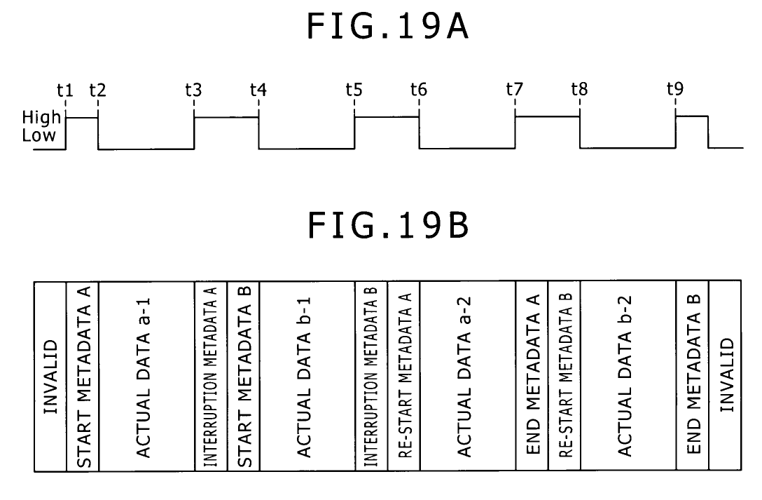

In the following, the data transmission process of FIG. 17 is described in more detail with reference to a particular example illustrated in FIGS. 18A to 18D and 19A and 19B.

In particular, the data transmission process of FIG. 17 where actual data a is generated at timing of FIG. 18A in the data source 11 and then actual data b is generated at timing of FIG. 18C in the data source 12 is described below.

In the example of FIGS. 18A to 18D, the data source 11 generates the actual data a prior to the data source 12. Therefore, by the process first at step S141, the data source 11 is set as the processing object data source.

In this instance, the processing advances through steps S142 (YES) and S143 (NO) to step S144, by the process at which start metadata (hereinafter referred to as start metadata A) regarding the data source 11 is produced. Then, by the process at step S145, the start metadata A is outputted to the data reception apparatus 2 through the data bus 41 as seen from FIG. 19B, and the metadata flag in the high level state is outputted to the data reception apparatus 2 through the control signal line 42 as seen from FIG. 19A.

Thereafter, the loop processes at steps S148, S149 and S152 are repeated, and the actual data a-1 of FIG. 18B from within the actual data a of the data source 11 is outputted to the data reception apparatus 2 through the data bus 41 as seen from FIG. 19B, and the metadata flag in the low level state is outputted to the data reception apparatus 2 through the control signal line 42 as seen from FIG. 19A.

Thereafter, if fixed time elapses, then a decision of YES is made by the process at step S149, and interruption metadata regarding the data source 11 (hereinafter referred to interruption metadata A) is produced by the process at step S150. Then, the interruption metadata A is outputted to the data reception apparatus 2 through the data bus 41 as seen from FIG. 19B, and the metadata flag in the high level state is outputted to the data reception apparatus 2 through the control signal line 42 as seen from FIG. 19A.

Thereafter, the processing is returned to step S141, at which now the data source 12 is set as the processing object data source.

In this instance, the processing advances through steps S142 (YES) and S143 (NO) to step S144, by the process at which start metadata regarding the data source 12 (hereinafter referred to as start metadata B) is produced. Then, by the process at step S145, the start metadata B is outputted to the data reception apparatus 2 through the data bus 41 as seen from FIG. 19B, and the metadata flag in the high level state is outputted to the data reception apparatus 2 through the control signal line 42 as seen from FIG. 19A.

Thereafter, the loop processes at steps S148, S149 and S152 are repeated, and the actual data b-1 of FIG. 18D from within the actual data b of the data source 12 is outputted to the data reception apparatus 2 through the data bus 41 as seen from FIG. 19B, and the metadata flag in the low level state is outputted to the data reception apparatus 2 through the control signal line 42 as seen from FIG. 19A.

Thereafter, if fixed time elapses, then a decision of YES is made by the process at step S149, and interruption metadata regarding the data source 12 (hereinafter referred to interruption metadata B) is produced by the process at step S150. Then, the interruption metadata B is outputted to the data reception apparatus 2 through the data bus 41 as seen from FIG. 19B by the process at step S151, and the metadata flag in the high level state is outputted to the data reception apparatus 2 through the control signal line 42 as seen from FIG. 19A.

Thereafter, the processing is returned to step S141, at which now the data source 11 is set as the processing object data source.

In this instance, the processing advances through steps S142 (YES) and S143 (YES) to step S146, by the process at which re-start metadata regarding the data source 11 (hereinafter referred to as re-start metadata A) is produced. Then, by the process at step S147, the re-start metadata A is outputted to the data reception apparatus 2 through the data bus 41 as seen from FIG. 19B, and the metadata flag in the high level state is outputted to the data reception apparatus 2 through the control signal line 42 as seen from FIG. 19B.

Thereafter, the loop processes at steps S148, S149 and S152 are repeated, and the actual data a-2, which is the remaining actual data with respect to the actual data a-1, of FIG. 18B from within the actual data a of the data source 11 is outputted to the data reception apparatus 2 through the data bus 41 as seen from FIG. 19B, and the metadata flag in the low level state is outputted to the data reception apparatus 2 through the control signal line 42 as seen from FIG. 19A.

Thereafter, if the transmission of the actual data a-2 ends, then a decision of YES is made by the process at step S152, and end metadata regarding the data source 11 (hereinafter referred to end metadata A) is produced by the process at step S153. Then, by the process at step S154, the end metadata A is outputted to the data reception apparatus 2 through the data bus 41 as seen from FIG. 19B and the metadata flag in the high level state is outputted to the data reception apparatus 2 through the control signal line 42 as seen from FIG. 19A.

Thereafter, the processing is returned to step S141, at which now the data source 12 is set as the processing object data source.

In this instance, the processing advances through steps S142 (YES) and S143 (YES) to step S146, by the process at which re-start metadata regarding the data source 12 (hereinafter referred to as re-start metadata B) is produced. Then, by the process at step S147, the re-start metadata B is outputted to the data reception apparatus 2 through the data bus 41 as seen from FIG. 19B, and the metadata flag in the high level state continues to be outputted to the data reception apparatus 2 through the control signal line 42 as seen from FIG. 19A.

Thereafter, the loop processes at steps S148, S149 and S152 are repeated, and the actual data b-2, which is the remaining actual data with respect to the actual data b-1, of FIG. 18D from within the actual data b of the data source 12 is outputted to the data reception apparatus 2 through the data bus 41 as seen from FIG. 19B, and the metadata flag in the low level state is outputted to the data reception apparatus 2 through the control signal line 42 as seen from FIG. 19A.

Thereafter, if the transmission of the actual data b-2 ends, then a decision of YES is made by the process at step S152, and end metadata regarding the data source 12 (hereinafter referred to end metadata B) is produced by the process at step S153. Then, the end metadata B is outputted to the data reception apparatus 2 through the data bus 41 as seen from FIG. 19B by the process at step S154, and the metadata flag in the high level state is outputted to the data reception apparatus 2 through the control signal line 42 as seen from FIG. 19A.

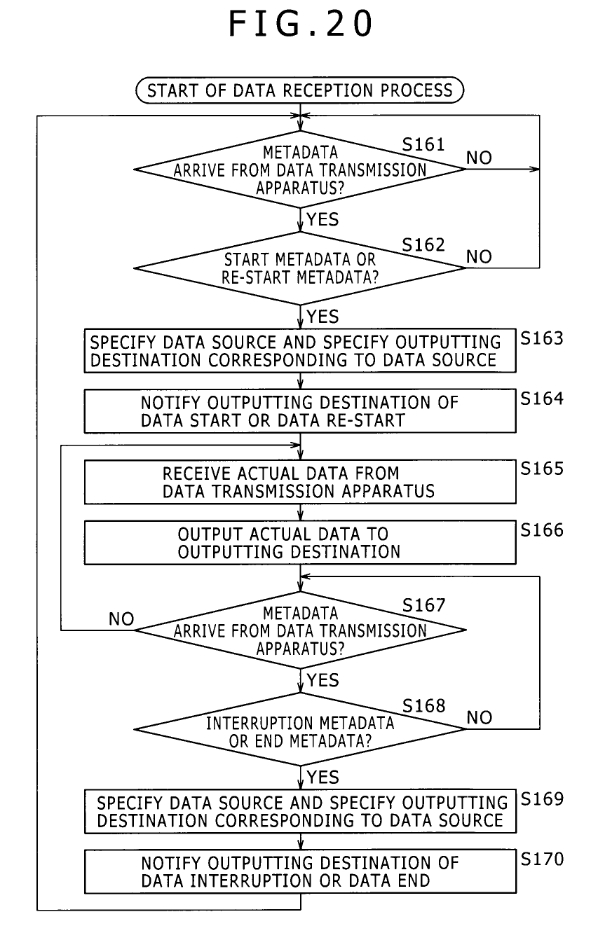

Now, an example of the data reception process corresponding to the data transmission process of FIG. 17 is described with reference to FIG. 20.

At step S161, the metadata/actual data separation section 31 of the data reception apparatus 2 decides whether or not metadata arrives from the data transmission apparatus 1. In particular, after the metadata/actual data separation section 31 starts the data reception process, it begins to supervise the signal level of the metadata flag transmitted along the control signal line 42.

In a state wherein the signal level of the metadata flag has the low level, the metadata/actual data separation section 31 decides that metadata does not arrive as yet and makes a decision of NO at step S161, and the processing returns to step S161 to repeat the process at step S161.

Thereafter, when the signal level of the metadata flag changes over from the low level to the high level, the metadata/actual data separation section 31 decides that metadata arrives and makes a decision of YES at step S161, and the processing advances to step S162.

At step S162, the metadata interpretation section 32 interprets the contents of the data type part (refer to FIG. 4) of the metadata and decides whether or not a result of the interpretation is the start metadata or the re-start metadata.

If the interpretation result is any other than the start metadata or the re-start metadata, then the metadata interpretation section 32 decides that the process at step S161 is a wrong decision and makes a decision of NO at step S162. Thus, the processing returns to step S161 to repeat the processes at the steps beginning with step S161. It is to be noted that, if the interpretation result is any other than the start metadata or the re-start metadata, then though not illustrated, for example, the data reception apparatus 2 may execute a predetermined error process to compulsorily end the data reception process.

On the other hand, if the interpretation result of the metadata type is the start metadata or the re-start metadata, then a decision of YES is made at step S162, and the processing advances to step S163.

At step S163, the metadata interpretation section 32 interprets the contents of the data source information part (refer to FIG. 4) of the metadata to specify the data source and specifies an outputting destination corresponding to the data source. In particular, for example, in the present embodiment, if the data source 11 is specified, then the outputting destination 13 is specified. On the other hand, if the data source 12 is specified, then the outputting destination 14 is specified.

At step S164, the data distribution section 33 issues a notification of a start of data or a re-start of data to the outputting destination. In particular, if the start metadata is received, then a start of the data is conveyed to the outputting destination. On the other hand, if the re-start metadata is received, then a re-start of data is conveyed to the outputting destination.

At step S165, the metadata/actual data separation section 31 receives the actual data from the data transmission apparatus 1. At step S166, the data distribution section 33 outputs the actual data to the data outputting destination.

At step S167, the metadata/actual data separation section 31 decides whether or not metadata arrives from the data transmission apparatus 1.

If the signal level of the metadata flag is the low level, then the metadata/actual data separation section 31 decides that metadata does not arrive as yet and makes a decision of NO at step S167, and the processing is returned to step S165 to repeat the processes at the steps beginning with step S165. In particular, the loop processes at steps S165 to S167 are repeated by the data reception apparatus 2 to receive and output the actual data in the form of streaming data to the data outputting destination for a period of time until metadata arrives.

Thereafter, if the signal level of the metadata flag changes over from the low level to the high level, then the metadata/actual data separation section 31 decides that metadata arrives and makes a decision of YES at step S167. Thus, the processing advances to step S168.

At step S168, the metadata interpretation section 32 interprets the contents of the metadata type part (refer to FIG. 4) of the metadata and decides whether or not a result of the interpretation is the interruption metadata or the end metadata.

If the interpretation result is any other than the interruption metadata or the end metadata, then the metadata interpretation section 32 decides that the process at step S167 is a wrong decision and makes a decision of NO at step S168. Thus, the processing is returned to step S167 to repeat the processes at the steps beginning with step S167. It is to be noted that, if the interpretation result is any other than the interruption metadata or the end metadata, then though not illustrated, for example, the data reception apparatus 2 may execute a predetermined error process to compulsorily end the data reception process.

On the other hand, if the interpretation result of the metadata type is the interruption metadata or the end metadata, then the metadata interpretation section 32 makes a decision of YES at step S168, and the processing advances to step S169.

At step S169, the metadata interpretation section 32 interprets the contents of the data source information part (refer to FIG. 4) of the metadata to specify the data source and specifies an outputting destination corresponding to the data source. In particular, for example, in the present embodiment, if the data source 11 is specified, then the outputting destination 13 is specified. On the other hand, if the data source 12 is specified, then the outputting destination 14 is specified.

At step S170, the data distribution section 33 notifies the outputting destination of an interruption of data or an end of data. In particular, if the interruption metadata is received, then an interruption of data is conveyed to the outputting destination. On the other hand, if the end metadata is received, then an end of data is conveyed to the outputting destination.

Thereafter, the processing is returned to step S161 to repeat the processes at the steps beginning with step S161.

In the following, the data reception process of FIG. 20 is described in more detail in connection with the particular example of FIGS. 19A and 19B. It is assumed here that the metadata having a waveform illustrated in FIG. 19A is inputted to the data reception apparatus 2 through the control signal line 42 and metadata-superposed actual data having an arrangement structure of FIG. 19B is inputted to the data reception apparatus 2 through the data bus 41.

At time t1, the signal level of the metadata changes over from the low level to the high level. Therefore, a decision of YES is made by the process at step S161, and the processing advances to step S162. The metadata arriving later than time t1 is the start metadata A. Therefore, it is specified that the received metadata is the start metadata from the contents of the metadata type part (refer to FIG. 4) of the metadata. Consequently, a decision of YES is made by the process at step S162, and the processing advances to step S163. By the process at step S163, the data source 11 is specified from the contents of the data source information part (refer to FIG. 4) of the start metadata A, and as a result, the outputting destination 13 is specified as the outputting destination.

Consequently, a start of data is conveyed to the outputting destination 13. Then, the loop processes at steps S165 to S167 are repeated to successively transfer the actual data a-1 successively transmitted to the data source 12 within the period from time t2 to time t3 to the outputting destination 13. It is to be noted that the signal level of the metadata changes over from the high level to the low level at time t2 and thereafter maintains the low level as seen from FIG. 19A.

Thereafter, at time t3, the signal level of the metadata changes over from the low level to the high level. Consequently, a decision of YES is made at step S167, and the processing advances to step S168. The metadata arriving later than time t3 is the interruption metadata A. Therefore, it is specified that the received metadata is the interruption metadata A from the contents of the metadata type part (refer to FIG. 4) of the metadata. Consequently, a decision of YES is made by the process at step S168, and the processing advances to step S169. The data source 11 is specified from the contents of the data source information (refer to FIG. 4) of the interruption metadata A, and as a result, the outputting destination 13 is specified as the outputting destination. Consequently, by the process at step S170, an interruption of data is conveyed to the outputting destination 13.

Thereafter, the processing is returned to step S161 again. As seen in FIG. 19B, following the interruption metadata A, the start metadata B is continuously inputted to the data reception apparatus 2. Therefore, the signal level of the metadata continues to be the high level. Consequently, a decision of YES is made by the process at step S161, and the processing advances to step S162. As described hereinabove, the metadata inputted to the data reception apparatus 2 at this stage is the start metadata B. Therefore, it is specified that the received metadata is the start metadata from the contents of the metadata type part (refer to FIG. 4) of the metadata. Consequently, a decision of YES is made by the process at step S162, and the processing advances to step S163. By the process at step S163, the data source 12 is specified from the contents of the data source information part (refer to FIG. 4) of the start metadata B, and as a result, the outputting destination 14 is specified as the outputting destination.

Consequently, a start of data is conveyed to the outputting destination 14. Then, the loop processes at steps S165 to S167 are repeated to successively transfer the actual data b-1, successively transmitted to the data source 12 within a period from time t4 to time t5, to the outputting destination 14. It is to be noted that the signal level of the metadata changes over from the high level to the low level at time t4 and thereafter remains the low level as seen from FIG. 19A.

Thereafter, at time t5, the signal level of the metadata changes over from the low level to the high level. Consequently, a decision of YES is made by the process at step S167, and the processing advances to step S168. The metadata which arrives later than time t5 is the interruption metadata B. Therefore, it is specified that the received metadata is the interruption metadata from the contents of the metadata information type part (refer to FIG. 4) of the metadata. Consequently, a decision of YES is made by the process at step S168, and the processing advances to step S169. By the process at step S169, the data source 12 is specified from the contents of the data source information type (refer to FIG. 4) of the interruption metadata B. As a result, the outputting destination 14 is specified as the outputting destination. Consequently, an interruption of data is conveyed to the outputting destination 14 by the process at step S170.

Thereafter, the processing is returned to step S161 again. As seen in FIG. 19B, following the interruption metadata B, the re-start metadata A is inputted to the data reception apparatus 2. Therefore, the signal level of the metadata continues to be the high level. Consequently, a decision of YES is made by the process at step S161, and the processing advances to step S162. As described hereinabove, the metadata inputted to the data reception apparatus 2 at this stage is the re-start metadata A. Therefore, it is specified that the received metadata is the re-start metadata from the contents of the metadata type part (refer to FIG. 4) of the metadata. Consequently, a decision of YES is made by the process at step S162, and the processing advances to step S163. By the process at step S163, the data source 11 is specified from the contents of the data source information part (refer to FIG. 4) of the re-start metadata A, and as a result, the outputting destination 13 is specified as the outputting destination.

Consequently, a re-start of data is conveyed to the outputting destination 13. Then, the loop process at steps S165 to S167 are repeated to successively transfer the actual data a-2, successively transmitted to the data source 12 within a period from time t6 to time t7, to the outputting destination 13. It is to be noted that the signal level of the metadata changes over from the high level to the low level at time t6 and thereafter remains the low level as seen from FIG. 19A.

Thereafter, at time t7, the signal level of the metadata changes over from the low level to the high level. Consequently, a decision of YES is decided by the process at step S167, and the processing advances to step S168. The metadata which arrives later than time t7 is the end metadata A. Therefore, it is specified that the received metadata is the end metadata from the contents of the metadata type part (refer to FIG. 4) of the metadata. Consequently, a decision of YES is made by the process at step S168, and the processing advances to step S169. By the process at step S169, the data source 11 is specified from the contents of the data source information part (refer to FIG. 4) of the end metadata A, and as a result, the outputting destination 13 is specified as the outputting destination. Consequently, by the process at step S170, an end of data is conveyed to the outputting destination 13.

Thereafter, the processing is returned to step S161 again. As seen in FIG. 19B, following the end metadata A, the re-start metadata B is inputted to the data reception apparatus 2. Therefore, the signal level of the metadata continues to be the high level. Consequently, a decision of YES is made by the process at step S161, and the processing advances to step S162. As described hereinabove, the metadata inputted to the data reception apparatus 2 at this stage is the re-start metadata B. Therefore, it is specified that the received metadata is the re-start metadata from the contents of the metadata type part (refer to FIG. 4) of the metadata. Consequently, a decision of YES is made by the process at step S162, and the processing advances to step S163. By the process at step S163, the data source 12 is specified from the contents of the data source information part (refer to FIG. 4) of the re-start metadata B, and as a result, the outputting destination 14 is specified as the outputting destination.

Consequently, a re-start of data is conveyed to the outputting destination 14. Then, the loop processes at steps S165 to S167 are repeated to successively transfer the actual data b-2, successively transmitted to the data source 12 within a period from time t8 to time t9, to the outputting destination 14. It is to be noted that the signal level of the metadata changes over from the high level to the low level at time t8 and thereafter remains the low level as seen from FIG. 19A.

Thereafter, at time t9, the signal level of the metadata changes over from the low level to the high level. Consequently, a decision of YES is decided by the process at step S167, and the processing advances to step S168. The metadata which arrives later than time t9 is the end metadata B. Therefore, it is specified that the received metadata is the end metadata from the contents of the metadata type part (refer to FIG. 4) of the metadata. Consequently, a decision of YES is made by the process at step S168, and the processing advances to step S169. By the process at step S169, the data source 12 is specified from the contents of the data source information part (refer to FIG. 4) of the end metadata B, and as a result, the outputting destination 14 is specified as the outputting destination. Consequently, by the process at step S170, an end of data is conveyed to the outputting destination 14.

The data transmission process of FIG. 17 and the data reception process of FIG. 20 are such as described above.

As described above, the information processing system of FIG. 1 can execute various data transmission processes and data reception processes. Therefore, the information processing system of FIG. 1 can achieve a first advantage that it can solve the first problem of the existing methods described hereinabove in the description of the summary of the invention.

In particular, according to the existing methods, where the data length of actual data is indefinite like continuous moving picture data, the data transmission apparatus side buffers actual data inputted from a data source to settle the data length and then produces a header including information of the data length. Therefore, the existing methods have a problem in that they require an internal buffer. This is the first problem of the existing methods.

In contrast, the data transmission apparatus 1 of the information processing system of FIG. 1 can control the transmission timing of actual data from the data source 11 in accordance with the processes described hereinabove with reference to the flow charts. Therefore, the data transmission apparatus 1 eliminates the necessity to buffer actual data from the data source 11. In other words, the data transmission apparatus 1 can achieve the first advantage that the buffer required by the existing methods is not required particularly as a component of the data transmission apparatus 1.

Further, the data transmission apparatus 1 of the information processing system of FIG. 1 can control the transmission timing of actual data using a control signal, that is, the metadata flag, representative of transmission timing of start metadata or end metadata. Such metadata flag can be transmitted only through a single line such as the control signal line 42. Further, such metadata flag is a signal which can be processed by a hardware board for exclusive use or the like without using a CPU (central processing unit). Therefore, the data transmission apparatus 1 can achieve a second advantage that it can solve also a second problem of the existing methods as described below.

In particular, where the data length of actual data is indefinite like continuous moving picture data, it is necessary to convey a start and an end of actual data to the reception side. In the past, a signal for conveying a start and an end of actual data is used occasionally. In such an instance, a problem occurs that two signal lines are demanded between the data transmission apparatus and the data reception apparatus. Further, if a CPU is incorporated in both of the data transmission apparatus and the data reception apparatus, then such transfer of a signal can be achieved between the two CPUs. In this instance, however, another problem occurs that the processing load to the CPUs increases. Furthermore, a CPU may not possibly be incorporated from a reason of reduction of the number of parts or the like, and also a problem occurs that it is not guaranteed to rely upon a CPU. Such problems as described are the second problem of the existing methods.

Furthermore, since, for example, the information processing system of FIG. 1 adopts the data transmission process described hereinabove with reference to FIGS. 11 and 12 and the data reception process described hereinabove with reference to FIGS. 15 and 16, the following third and fourth advantages can be achieved in addition to the first and second advantages described above.

In the past, a technique is available wherein a plurality of data sources are provided for a data transmission apparatus and data from the data sources are transmitted time-divisionally through a data bus. However, in order to embody the existing technique, it is necessary to distinguish the data sources, and an identification signal for identifying a data source is used occasionally in the past. In such an instance, a plurality of signal lines are required to transmit such an identification signal, and this gives rise to a third problem that the number of signal lines increases. That such a third problem of the existing methods as just described can be solved is the third advantage of the data transmission apparatus 1 of the information processing system of FIG. 1.

In particular, the data transmission apparatus 1 of the information processing system of FIG. 1 accommodates identification information for identifying a plurality of data sources into metadata and uses only a control signal, that is, a metadata flag, indicative of transmission timing of the metadata. This metadata flag can be transmitted only by a single signal line, that is, by the control signal line 42 described hereinabove. Therefore, the third advantage that the third problem of the existing methods can be solved can be achieved.

Also, in the past, preferentiality control is used wherein, where a plurality of data sources are different in preferentiality, if the comparatively preferential data source has preferential data during transmission of non-preferential data by the data transmission apparatus, then the preferential data is transmitted preferentially. In order to carry out such preferential control, it is necessary to interrupt the transmission of the non-preferential data and then start transmission of the preferential data. Accordingly, it is necessary for the data transmission apparatus to issue a notification of changeover from non-preferential data to preferential data to the data reception apparatus. Similarly, also it is necessary to issue a notification of changeover from preferential data to non-preferential data. In such instances, a problem occurs that two signal lines are additionally demanded between the data transmission apparatus and the data reception apparatus. As described above in connection with the second problem of the existing methods, where use of a CPU is taken into consideration, also a problem similar to the second problem of the existing methods occurs. Such problems as described above are generically referred to as fourth problem of the existing methods. In this instance, the advantage that the fourth problem of the existing methods can be solved is the fourth advantage of the data transmission apparatus 1.

In particular, the data transmission apparatus 1 of the information processing system of FIG. 1 uses interruption metadata and re-start metadata to carry out such changeover control of preferential/non-preferential data as described above. Further, the data transmission apparatus 1 of the information processing system of FIG. 1 uses only a control signal, that is, the metadata flag, indicative of transmission timing of the interruption metadata and the re-start metadata. This metadata flag can be transmitted using only a single signal line, that is, the control signal line 42, as described hereinabove. Therefore, the fourth advantage that also the fourth problem of the existing methods can be solved can be achieved.

Incidentally, while the series of processes described above can be executed by hardware, it may otherwise be executed by software.

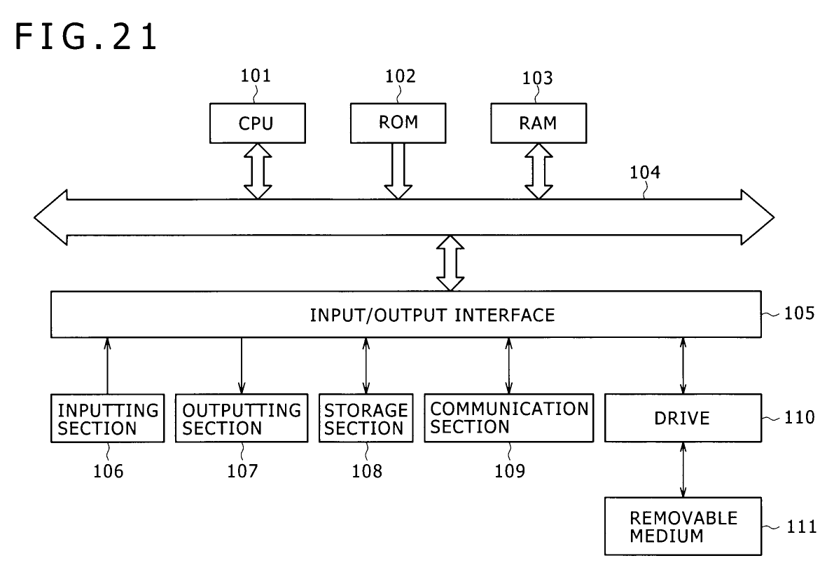

In this instance, at least part of the information processing system described above may be formed using, for example, such a computer as shown in FIG. 21.

Referring to FIG. 21, a central processing unit (CPU) 101 executes various processes in accordance with a program stored in a ROM (Read Only Memory) 102 or a program loaded from a storage section 108 into a RAM (Random Access Memory) 103. Also data necessary for the CPU 101 to execute various processes are suitably stored into the RAM 103.

The CPU 101, ROM 102 and RAM 103 are connected to one another by a bus 104. Also an input/output interface 105 is connected to the bus 104.

An inputting section 106 including a keyboard, a mouse and so forth, an outputting section 107 including a display unit and so forth, a storage section 108 formed from a hard disk or the like, a communication section 109 including a modem, a terminal adapter and so forth are connected to the input/output interface 105. The communication section 109 controls communication with another apparatus not shown to be carried out through a network including the Internet.

Further, as occasion demands, a drive 110 is connected to the input/output interface 105. A magnetic disk, an optical disk, a magneto-optical disk, a semiconductor memory or the like is suitably loaded into the drive 110, and a computer program read out from the loaded medium is installed into the storage section 108 as occasion demands.

Where the series of processes is executed by software, a program which constructs the software is installed from a network or a recording medium into a computer incorporated in hardware for exclusive use or, for example, a personal computer for universal use which can execute various functions by installing various programs.

The recording medium which includes such a program as described above is formed as a removable medium or package medium 111 such as, as shown in FIG. 21, a magnetic disc (including a floppy disc), an optical disc (including a CD-ROM (Compact Disc-Read Only Memory) and a DVD (Digital Versatile Disc)), or a magneto-optical disc (including an MD (MiniDisc, Registered Trademark of Sony Corporation)), or a semiconductor memory which has the program recorded thereon or therein and is distributed to provide the program to a user separately from an apparatus body. Else, the recording medium is formed as the ROM 102, a hard disc included in the storage section 108 or the like in which the program is recorded and which is provided to a user in a state wherein the program is incorporated in a computer.

It is to be noted that, in the present specification, the steps which describe the program recorded in a recording medium may be but need not necessarily be processed in a time series in the order as described, and include processes which are executed in parallel or individually without being processed in a time series.

Further, in the present specification, the term “system” is used to represent an entire apparatus composed of a plurality of processing devices or apparatus or processing sections.

The present application contains subject matter related to that disclosed in Japanese Priority Patent Application JP 2008-105745 filed in the Japan Patent Office on Apr. 15, 2008, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A transmission apparatus, comprising:
control means for controlling the timing at which actual data from a data source is to be transmitted to a reception apparatus; and
transmission means for producing a control signal representative of the contents of the control of said control means, transmitting the control signal to the reception apparatus through a first signal line, receiving the actual data from the data source under the control of said control means and transmitting the received actual data to the reception apparatus through a second signal line.

2. The transmission apparatus according to claim 1, further comprising:
metadata production means for producing metadata regarding the actual data;
said control means further controlling the timing at which the metadata produced by said metadata production means is to be transmitted,
said transmission means being further operable to produce the control signal so as to further include the contents of the control of the transmission timing of the metadata, transmit the control signal through the first signal line and further transmit the metadata to the reception apparatus through the second transmission line.

3. The transmission apparatus according to claim 2, wherein said metadata production means produces, as the metadata, start metadata indicative of a start of transmission of the actual data and end metadata indicative of an end of the transmission of the actual data.

4. The transmission apparatus according to claim 2, wherein
said control means is associated with a plurality of data sources, and
said metadata production means produces the metadata so as to include data source information for specifying one of the data sources from which the actual data is outputted.

5. The transmission apparatus according to claim 4, wherein
said control means further carries out control of changing over the operative data source from which actual data of an object of transmission is to be outputted; and
said metadata production means further produces, when the operative data source is changed over from a first one of the data sources to a second one of the data sources under the control of said control means, intermediate metadata indicative of an interruption of transmission of actual data of the first data source, and thereafter produces, when the operative data source is changed over from the second data source to the first data source under the control of said control means, re-start metadata indicative of a re-start of the transmission of the actual data of the first data source.

6. The transmission apparatus according to claim 2, wherein said metadata production means further produces data length metadata indicative of the data length of the actual data.

7. A transmission method for being carried out by a transmission apparatus, comprising the steps of:
carrying out transmission timing control of controlling the transmission timing of actual data from a data source to a reception apparatus; and
producing a control signal representative of the contents of the transmission timing control of the actual data, transmitting the control signal to the reception apparatus through a first signal line, receiving the actual data from the data source under the transmission timing control of the actual data and transmitting the received actual data to the reception apparatus through a second signal line.

8. A program for causing a computer to execute a control process which comprises the steps of:
carrying out transmission timing control of controlling the transmission timing of actual data from a data source to a reception apparatus; and
producing a control signal representative of the contents of the transmission timing control of the actual data, transmitting the control signal to the reception apparatus through a first signal line, receiving the actual data from the data source under the transmission timing control of the actual data and transmitting the received actual data to the reception apparatus through a second signal line.

9. A reception apparatus, comprising:
reception control means for receiving, when a control signal representative of contents of control regarding transmission timing of actual data is transmitted from a transmission apparatus, which transmits the actual data from a data source, through a first signal line and the actual data is transmitted from the transmission apparatus through a second signal line, the control signal and carrying out control of receiving the actual data based on the control signal.

10. The reception apparatus according to claim 9, wherein, when metadata regarding the actual data is transmitted further from the transmission apparatus through the second signal line and the control signal which further includes contents of control of transmission timing of the metadata is transmitted from the transmission apparatus through the first signal line, said reception control means further carries out control of receiving the metadata based on the control signal.

11. The reception apparatus according to claim 10, further comprising:
metadata interpretation means for interpreting the metadata received by the control of said reception control means to specify the type of the metadata.

12. The reception apparatus according to claim 11, wherein the metadata specified by said metadata interpretation means is one of start metadata indicative of a start of transmission of the actual data and end metadata indicative of an end of the transmission of the actual data.

13. The reception apparatus according to claim 12, wherein
the metadata includes data source information for specifying one of a plurality of data sources associated with the transmission apparatus from which the actual data is outputted, and
said metadata interpretation means further interprets the data source information to specify the data source.

14. The reception apparatus according to claim 13, wherein
the actual data outputted from the data sources are outputted from said reception apparatus to respective outputting destinations determined in advance, and
said reception apparatus further comprises:
distribution means for distributing the actual data received by said reception control means to that one of the outputting destinations which corresponds to the data source specified by said metadata interpretation means.

15. The reception apparatus according to claim 14, wherein
said metadata interpretation means specifies the metadata between interruption metadata produced by the transmission apparatus when the operative data source which is to output actual data of a transmission object is changed over from a first one of the data sources to a second one of the data sources and indicative of an interruption of transmission of actual data of the first data source and re-start metadata produced by the transmission apparatus when the data source is changed over from the second data source to the first data source and indicative of a re-start of the transmission of the actual data of the first data source, and
said distribution means changes over, when the interruption metadata regarding the first data source is specified by said metadata interpretation means, the outputting destination of the actual data to any other than the outputting destination corresponding to the first data source, and then changes over, when the re-start metadata regarding the first data source is specified by said metadata interpretation means, the outputting destination of the actual data back to the outputting destination which corresponds to the first data source.

16. The reception apparatus according to claim 15, wherein said metadata interpretation means can specify, as the metadata to be specified thereby, data length metadata representative of the data length of the actual data.

17. A reception method for being carried out by a reception apparatus which receives actual data from a transmission apparatus, the reception method comprising the step of:
receiving, when a control signal representative of contents of control regarding transmission timing of actual data is transmitted from the transmission apparatus, which transmits the actual data from a data source, through a first signal line and the actual data is transmitted from the transmission apparatus through a second signal line, the control signal and carrying out control of receiving the actual data based on the control signal.

18. A program for causing a computer, which controls reception of actual data from a transmission apparatus, to execute a control process which comprises the step of:
receiving, when a control signal representative of contents of control regarding transmission timing of actual data is transmitted from the transmission apparatus, which transmits the actual data from a data source, through a first signal line and the actual data is transmitted from the transmission apparatus through a second signal line, the control signal and carrying out control of receiving the actual data based on the control signal.

19. A transmission and reception system, comprising:
a transmission apparatus including
control means for controlling the timing at which actual data from a data source is to be transmitted to a reception apparatus, and
transmission means for producing a control signal representative of the contents of the control of said control means, transmitting the control signal to the reception apparatus through a first signal line, receiving the actual data from the data source under the control of said control means and transmitting the received actual data to the reception apparatus through a second signal line; and
a reception apparatus including
reception control means for receiving the control signal and carrying out control of receiving the actual data based on the control signal.

20. A transmission and reception method, comprising the steps of:
carried out by a transmission apparatus, carrying out control of the timing at which actual data from a data source is to be transmitted to a reception apparatus;
carried out by the transmission apparatus, producing a control signal representative of the contents of the control and transmitting the control signal to the reception apparatus through a first signal line;
carried out by the transmission apparatus, receiving the actual data from the data source under the control and transmitting the received actual data to the reception apparatus through a second signal line; and
carried out by the reception apparatus, receiving the control signal and carrying out control of receiving the actual data based on the control signal.

21. A transmission apparatus, comprising:
a control section configured to control the timing at which actual data from a data source is to be transmitted to a reception apparatus; and
a transmission section configured to produce a control signal representative of the contents of the control of said control section, transmit the control signal to the reception apparatus through a first signal line, receive the actual data from the data source under the control of said control section and transmit the received actual data to the reception apparatus through a second signal line.

22. A reception apparatus, comprising:
a reception control section configured to receive, when a control signal representative of contents of control regarding transmission timing of actual data is transmitted from a transmission apparatus, which transmits the actual data from a data source, through a first signal line and the actual data is transmitted from the transmission apparatus through a second signal line, the control signal and carry out control of receiving the actual data based on the control signal.
